(19) United States
(12) Patent Application Publication
(10) Pub. No.: US 2026/0009762 A1
(43) Pub. Date: Jan. 8, 2026

(54) FLEXIBLE CAPILLARY ARRAY DEVICE AND RELATED SYSTEMS AND METHODS

(71) Applicant: Agilent Technologies, Inc., Santa Clara, CA (US)

(72) Inventors: Paul GRIESZ, Santa Clara, CA (US); Bruce Richard BOEKE, Santa Clara, CA (US); Mark VER MEER, Santa Clara, CA (US); Tobias GLEICHMANN, Santa Clara, CA (US)

(73) Assignee: Agilent Technologies, Inc., Santa Clara, CA (US)

(21) Appl. No.: 18/880,814

(22) PCT Filed: May 8, 2023
(86) PCT No.: PCT/US2023/021404

§ 371 Date: Jan. 2, 2025

Related U.S. Application Data
(60) Provisional application No. 63/388,593, filed on Jul. 12, 2022.

(51) Int. Cl. G01N 27/447

(52) U.S. Cl. CPC G01N 27/44782; G01N 27/44721; G01N 27/44743

(57) ABSTRACT

A capillary array device includes a flexible component allowing movement of at least part of the device relative to an array of capillaries, thereby allowing different materials to be loaded into the capillaries. The capillaries may be utilized to contain samples that are to be measured by a capillary electrophoresis (CE) instrument or other type of analytical instrument.

### RELATED APPLICATIONS

This application claims the benefit under 35 U.S.C. § 119(e) of U.S. Provisional Patent Application Ser. No. 63/388,593, filed Jul. 12, 2022, titled “FLEXIBLE CAPILLARY ARRAY DEVICE AND RELATED SYSTEMS AND METHODS,” the entire contents of which are incorporated by reference herein.

### TECHNICAL FIELD

The present invention generally relates to a capillary array device for holding a parallel arrangement of capillaries. In particular, the invention relates to a capillary array device that has a flexible component allowing movement of part of the device relative to the capillaries. The capillaries may be utilized to contain samples that are to be detected or measured by an optics-based instrument. The capillaries may be utilized, for example, for capillary electrophoresis (CE).

### BACKGROUND

Analytical instruments often utilize capillaries (i.e., tubes with bores on the scale of micrometers) to contain and transport sample-containing fluids (in either liquid phase or gas phase) for various purposes. In some analytical instruments, a capillary—or at least an optically transparent section of a capillary, referred to as a capillary window—may be utilized as a sample detection cell. In this case, the analytical instrument is configured to make optical-based measurements (e.g., fluorescence, absorbance, imaging, etc.) of analytes of a sample (i.e., sample components of interest such as chemical compounds or biological compounds) contained in the capillary by reading electromagnetic energy emitted from the sample. Such emission may be in response to the sample being irradiated by a beam of electromagnetic energy directed to the capillary (window) by a light source of the analytical instrument. In some analytical instruments, the capillary may include in its lumen (inner bore) a separation medium formulated to separate different analytes of the sample on the basis of different properties or attributes, such as molecular size, molecular composition, electrical charge, etc. In some analytical techniques, the separation medium may be stationary (i.e., a stationary phase) within the capillary. In this case, the sample is carried by a fluid (i.e., a mobile phase, such as one or more solvents) through the capillary and into contact with the separation medium. As the sample migrates through the separation medium, different analytes of the sample become separated from each other, thereby facilitating detection/measurement of the analytes by the analytical instrument. Examples of analytical separation techniques include capillary electrophoresis (CE, particularly capillary gel electrophoresis or CGE), liquid chromatography (LC), and gas chromatography (GC).

Sample analysis may be enhanced by operating multiple capillaries (or capillary windows thereof) in parallel, with each capillary containing an individual sample. In this case, the analytical instrument may be configured to read, or in addition irradiate, the multiple capillaries simultaneously.

Many of the components of a CE system or other analytical separation system can be realized on the scale of microfluidics, meaning that one or more dimensions of such components are on the order of micrometers, or additionally other dimensions are on the order of millimeters. Hence, many of these components can be embodied in/on, or be coupled to, one or more microfluidic chips. Typically, the conduits provided for transporting fluids (and chambers or other enclosed spaces) are channels formed between glass layers of the microfluidic chips. Such microfluidic chips are often fabricated from glass with the use of glass etching and glass bonding techniques. Fabrication of these microfluidic chips is expensive, and the designs of the microfluidic chips are limited by the fabrication techniques available for them (e.g., 2.5-D design limitations due to the etching steps required). In addition, complex procedures are often required to prepare microfluidic chips for use with an analytical instrument. Such procedures may include priming the fluid conduits and chambers of a microfluidic chip with fluid (e.g., by operating a priming station external to the analytical instrument), and transporting liquids and gels to the microfluidic chip by operating fluid handling systems involving various liquid or gel reservoirs, tubing, pumps, valves, etc. In addition, the capillaries often are preloaded with an analytical separation medium (e.g., a CE gel, chromatographic stationary phase, etc.), which leads to problems relating to limited shelf life and degradation of the analytical separation medium.

There is an ongoing need to provide capillary array devices that address challenges such as those noted above and/or that provide other advantages in the performance of analytical runs on samples in capillaries.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to an embodiment, a capillary array device includes: a capillary array holder comprising a stationary section, a movable section, and a flexible section coupling the stationary section and the movable section; and a plurality of capillaries attached to the capillary array holder, wherein the capillaries are arranged in parallel and elongated along a device axis of the capillary array holder, and wherein: the movable section is linearly movable along the device axis relative to the capillaries and the stationary section; and the flexible section flexes in response to movement of the movable section.

In an embodiment, the capillary array device further includes a voltage source configured to apply a potential difference across the capillaries.

In an embodiment, the voltage source is configured to apply the potential difference according to operating parameters effective for performing capillary electrophoresis on samples disposed in the capillaries.

According to another embodiment, a sample analysis system includes: a capillary array device according to any of the embodiments disclosed herein; and a light detector positioned in optical alignment with the capillaries to receive light emitted from the capillaries.

In an embodiment, the sample analysis system further includes a voltage source configured to apply a potential difference across the capillaries.

In an embodiment, the voltage source is configured to apply the potential difference according to operating parameters effective for performing capillary electrophoresis on samples disposed in the capillaries.

According to another embodiment, a method for injecting a liquid or gel into a plurality of capillaries includes: providing a capillary array device comprising the plurality of capillaries and a capillary array holder, wherein: the capillary array holder comprises a stationary section, a movable section, and a flexible section coupling the stationary section and the movable section; and the capillaries are attached to the capillary array holder, and are arranged in parallel and elongated along a device axis of the capillary array holder; moving the movable section along the device axis to a position at which the capillaries extend into one or more containers of the capillary array holder, wherein the liquid or gel is contained in the one or more containers, and the flexible section flexes in response to movement of the movable section; and injecting the liquid or gel from the one or more containers into the capillaries by capillary action.

In an embodiment, the containers respectively contain samples to be analyzed, and the injecting comprises respectively injecting the samples into the capillaries.

In an embodiment, the method further includes, after the injecting, applying a voltage across each of the capillaries along the device axis, wherein the voltage is applied according to operating parameters effective for performing capillary electrophoresis on the samples.

According to another embodiment, a method for analyzing a sample includes: injecting the liquid or gel into the capillaries according to any of the embodiments disclosed herein, wherein the liquid or gel comprises samples to be analyzed, and the injecting comprises respectively injecting the samples into the capillaries; and making an optical measurement of samples in the capillaries to acquire optical data from one or more analytes of the samples.

In an embodiment, the method further includes, before and/or during the making of the optical measurement, analytically separating the samples in each capillary.

In an embodiment, the analytically separating of the samples comprises performing capillary electrophoresis on the samples.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1A is a top plan view of an example of a capillary array device according to an embodiment of the present disclosure, shown in a first position.

FIG. 1B is a top plan view of the capillary array device illustrated in FIG. 1A, shown in a second position.

FIG. 1C is a top plan view of the capillary array device illustrated in FIG. 1A, shown in a third position.

FIG. 1D is a longitudinal side elevation view of the capillary array device illustrated in FIG. 1A, shown coupled to an actuator according to an embodiment of the present disclosure.

FIG. 1E is a longitudinal side elevation view of the capillary array device illustrated in FIG. 1A, shown coupled to an electrical circuit according to an embodiment of the present disclosure.

FIG. 1F is a longitudinal side elevation view of the capillary array device illustrated in FIG. 1A, shown coupled to an optics-based measurement device according to an embodiment of the present disclosure.

FIG. 2 is an exploded view of the capillary array device illustrated in FIG. 1A and an example of a device support, according to an embodiment of the present disclosure.

FIG. 3 is a longitudinal side elevation view of another example of a capillary array device according to another embodiment of the present disclosure.

FIG. 4A is a top perspective view of another example of a capillary array device according to another embodiment of the present disclosure.

FIG. 4B is a top plan view of the capillary array device illustrated in FIG. 4A.

FIG. 4C is a cut-away, perspective top view of the capillary array device illustrated in FIG. 4A, taken along line A-A shown in FIG. 4B.

FIG. 4D is a cut-away, longitudinal side elevation view of the capillary array device illustrated in FIG. 4A, taken along line A-A shown in FIG. 4B.

FIG. 4E is a top plan view of the capillary array device illustrated in FIG. 4A, shown in a first position.

FIG. 4F is a top plan view of the capillary array device illustrated in FIG. 4A, shown in a first position.

FIG. 4G is a top plan view of the capillary array device illustrated in FIG. 4A, shown in a first position.

FIG. 5A is a top perspective view of another example of a capillary array device according to another embodiment of the present disclosure.

FIG. 5B is a top plan view of the capillary array device illustrated in FIG. 5A.

FIG. 6A is a top perspective view of another example of a capillary array device according to another embodiment of the present disclosure.

FIG. 6B is a top plan view of the capillary array device illustrated in FIG. 6A.

FIG. 7A is a longitudinal side elevation view of another example of a capillary array device according to another embodiment of the present disclosure, shown in a non-actuated position.

FIG. 7B is a longitudinal side elevation view of the capillary array device illustrated in FIG. 7A, shown in an actuated position.

FIG. 8 is a schematic view of an example of a sample analysis system according to an embodiment of the present disclosure.

The illustrations in all of the drawing figures are considered to be schematic, unless specifically indicated otherwise.

### DETAILED DESCRIPTION

In this disclosure, all “aspects,” “examples,” and “embodiments” described are considered to be non-limiting and non-exclusive. Accordingly, the fact that a specific “aspect,” “example,” or “embodiment” is explicitly described herein does not exclude other “aspects,” “examples,” and “embodiments” from the scope of the present disclosure even if not explicitly described. In this disclosure, the terms “aspect,” “example,” and “embodiment” are used interchangeably, i.e., are considered to have interchangeable meanings.

In this disclosure, the term “substantially,” “approximately,” or “about,” when modifying a specified numerical value, may be taken to encompass a range of values that include +/−10% of such numerical value.

In the context of this disclosure, the term “light” refers to electromagnetic energy (i.e., photons) in a general sense and thus is not limited to electromagnetic energy only in the visible range. Depending on the embodiment, the wavelength range transmitted to or emitted from capillaries may be in the ultraviolet range, the visible range, the infrared range, or a combination or overlap of two or more of these ranges. In the context of this disclosure, the ultraviolet range is taken as spanning from 10 nanometers (nm) to 400 nm, the visible range is taken as spanning from 400 nm to 700 nm, and the infrared range is taken as spanning from 700 nm to 1000 nm (1 millimeter (mm)), with the recognition that the foregoing ranges may slightly differ and/or may slightly overlap depending on the technical source relied upon for reference or definition.

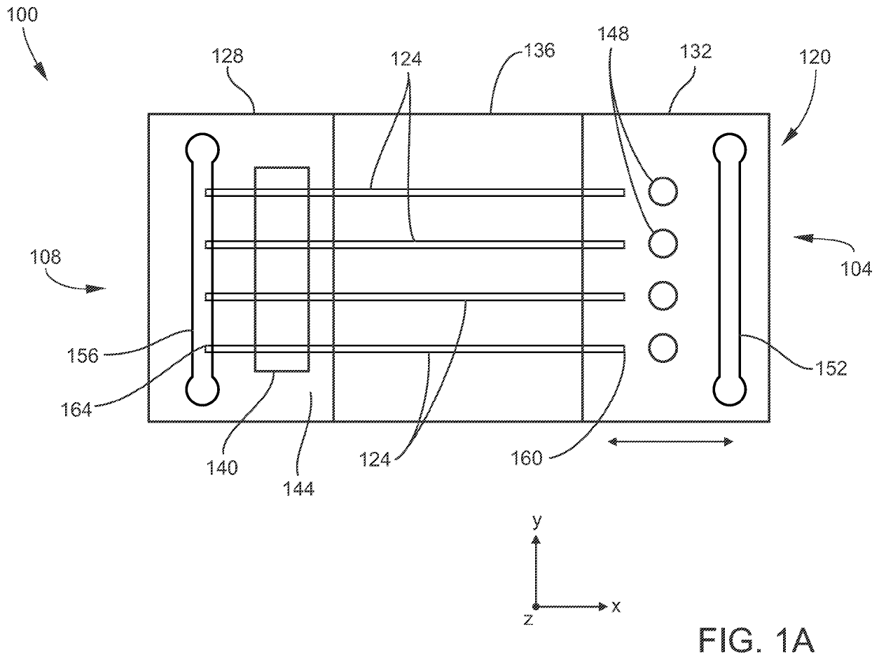

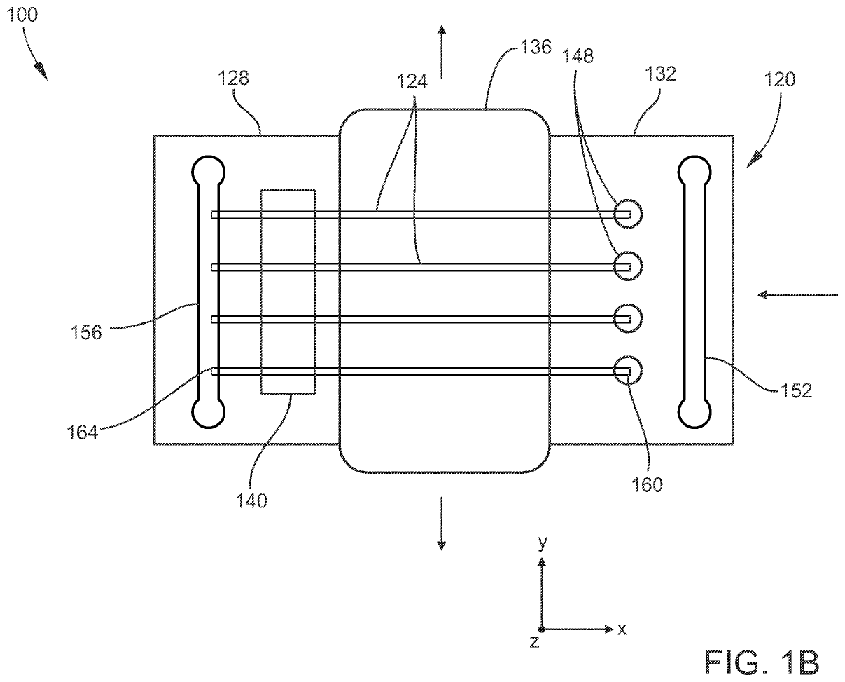

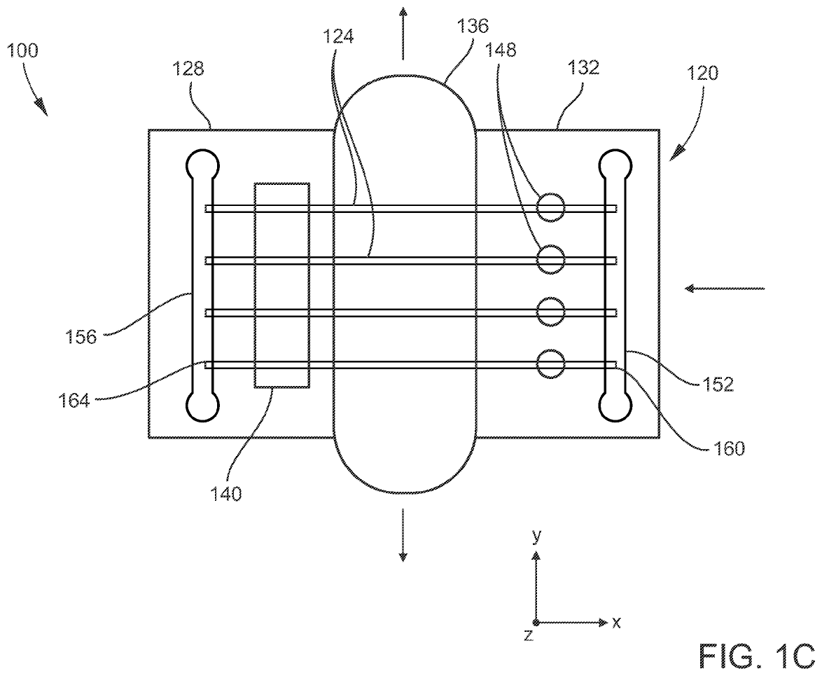

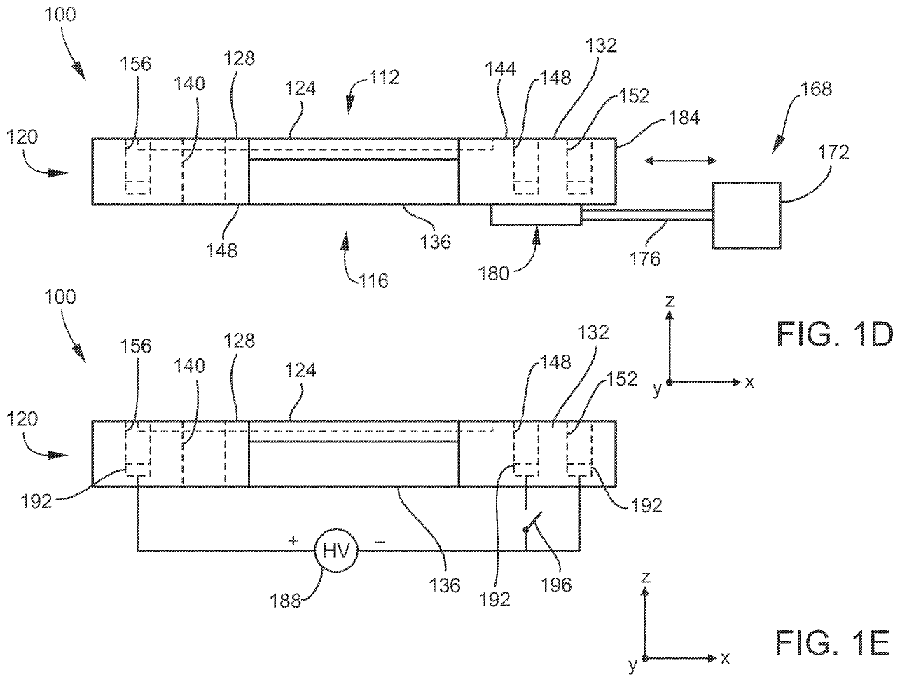

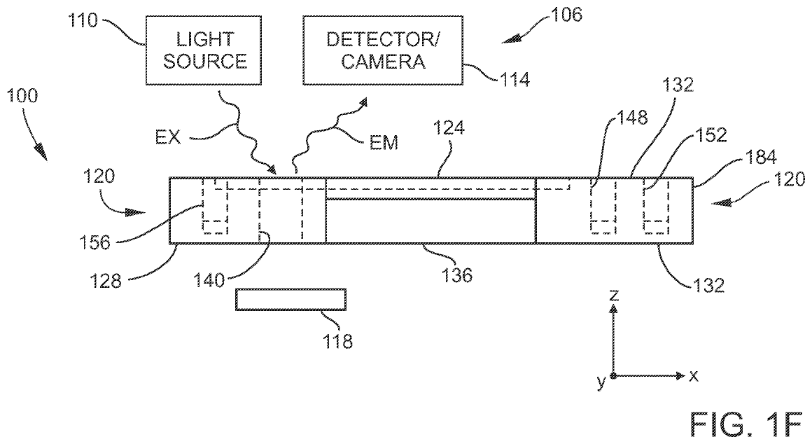

FIGS. 1A-1F illustrate non-exclusive examples of a capillary array device 100 according to embodiments of the present disclosure. For purposes of reference and description, FIGS. 1A-1F (and other drawing figures) include an arbitrarily positioned Cartesian coordinate (x-y-z) frame. The x-axis, y-axis, and z-axis are also referred to herein as the device axis (or capillary axis), transverse axis, and elevational axis, respectively. The x-y plane is referred to herein as the device plane (or capillary plane). The y-z plane is referred to herein as the transverse plane. Dimensions along the x-axis, y-axis, and z-axis are taken to be length, width, and height (or thickness), respectively. Also for purposes of reference and description, the x-y plane is assumed to be a horizontal plane relative to ground (i.e., a surface on which the capillary array device 100, or an instrument in which the capillary array device 100 is installed, rests), and the z-axis is assumed to be a vertical direction. More generally, however, the capillary array device 100 is not limited to any particular orientation relative to ground. In the context of the present disclosure, the term “axial” relates to the device axis (x-axis), unless specified otherwise or the context dictates otherwise.

FIG. 1A is a top plan view of the capillary array device 100. In this example, the capillary array device 100 generally has an overall planar geometry (i.e., is shaped as a plate, chip, etc.) and is elongated along the device axis (x-axis). That is, the largest overall dimension of the capillary array device 100 is its length, although the capillary array device 100 is not limited to such geometry. Generally, the capillary array device 100 has a first axial end 104 and an axially opposing second axial end 108, which define the overall length of the capillary array device 100. The capillary array device 100 further has a top side 112 and a bottom side 116 (FIG. 1D) lying in the device (x-y) plane. In the context of this disclosure, the terms “top” and “bottom” are relative to each other only, for distinguishing them from each other, and are not intended to limit the capillary array device 100 to any particular orientation relative to ground or to any other reference datum.

Generally, the capillary array device 100 includes a capillary array holder 120 and a plurality of capillaries 124. The capillary array holder 120 is configured to securely hold the capillaries 124 in a parallel arrangement. In this arrangement, the capillaries 124 are elongated along the device axis, spaced from each other along the transverse axis, and retained in fixed positions and at fixed distances from each other. For this purpose, the capillary array holder 120 may include grooves or channels at various locations (not shown, but described further below) that receive the capillaries 124, and which also may guide relative movement between (a part of) the capillary array holder 120 and the capillaries 124 as described below. In the present example, four capillaries 124 are provided, but the capillary array device 100 may include any number of capillaries 124.

The capillary array holder 120 is defined by a structural frame or body of material. The body may be single-piece (monolithic) or may include two or more parts attached (e.g., bonded, adhered, welded, etc.) or fastened (e.g., mechanically) together. The (body of the) capillary array holder 120 may include one or more stationary sections 128, one or more movable sections 132, and one or more flexible sections (or flexible couplings) 136 that are coupled to the stationary section(s) 128 and/or the movable section(s) 132. The stationary section(s) 128 are configured to be fixed in place, such as by being appropriately mounted to a device support or receptacle that is part of, or is in turn mounted to/in, an associated analytical instrument. The movable section(s) 132 are configured to have at least one degree of freedom of movement, particularly along the device axis, which may be enabled and guided by an appropriately configured device support. A double-headed arrow in FIG. 1A depicts linear movement of a movable section 132 alternately toward and away from the capillaries 124 and a stationary section 128.

The stationary section(s) 128 and the movable section(s) 132 generally may be configured as mostly solid bodies of material. Depending on the embodiment, the stationary section(s) 128 and the movable section(s) 132 may include various features provided (formed, engineered, added, etc.) on, in, or through their bodies, such as for holding or conducting liquids or gels, supporting or guiding the capillaries, accommodating or defining pathways for light transmission, mounting to a device support, engaging an actuator, communicating with electrical circuitry, providing identification of the capillary array holder 120 or other information, etc.

The flexible section(s) 136 are configured to enable the movable section(s) 132 to move, particularly to linearly translate along the device axis, relative to the capillaries 124 and the stationary section(s) 128. For this purpose, the flexible section(s) 136 are configured to flex (or deform, dilate, etc.) in response to movement of the movable section(s) 132. Depending on the configuration, this “flexing” may involve movement, and also compression and/or expansion/extension (e.g., stretching), of one or more portions of the flexible section(s) 136 in one or more directions. In context of this disclosure, a flexible section 136 is “flexible” (or has a “flexible” configuration) relative to the movable section 132 (or relative to both the movable section 132 and the stationary section 128). Stated in another way, the movable section 132 (or both the movable section 132 and the stationary section 128) is “rigid” relative to the flexible section 136. The flexible section 136 is “flexible” in the sense that is more flexible, or more compliant (or weaker), than the stationary section 128 and/or movable section 132 to which it is attached. Stated in another way, in response to an applied (actuation) force, the flexible section 136 will readily yield to the applied force by “flexing” and will not transfer a significant amount of the applied force to the stationary section 128, whereas the movable section 132 will not flex but instead will move toward (in the direction of) the flexible section 132 and transfer all or most of the applied force to the flexible section 132.

In some embodiments of a flexible configuration, the flexible section 136 may have an “open frame” configuration (not shown in FIGS. 1A-1F, but described by examples below). Such open frame configuration may be the primary contributor to the flexibility of the flexible section 136, in comparison to the inherent flexibility of the solid material of the flexible section 136. With an open frame configuration, the three-dimensional space occupied by the flexible section 136 may be predominantly open space instead of solid material, particularly in comparison to the stationary section 128 and the movable section 132. Most of the three-dimensional space occupied by the stationary section 128 and the movable section 132 is solid material, which renders the stationary section 128 and the movable section 132 structurally more rigid (less flexible and less compliant) and stronger or more robust, and thus more resistant to deformation (and less responsive to an applied force), than the flexible section 136. By comparison, a large percentage of the three-dimensional space occupied by the flexible section 136 is open space. As examples of “predominantly open space” or “large percentage of open space,” the percentage of the three-dimensional space occupied by the flexible section 136 that is open space may be greater than 30%, or greater than 50%, or greater than 70%.

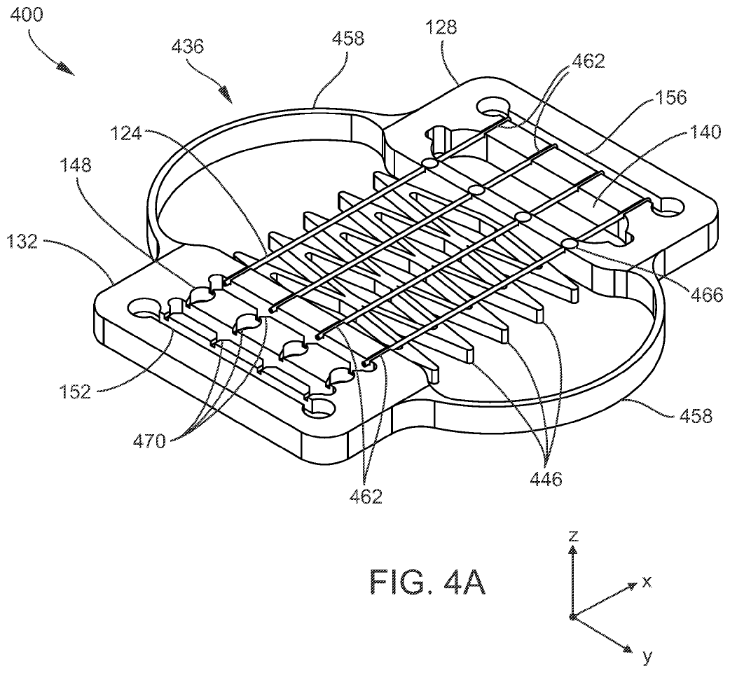

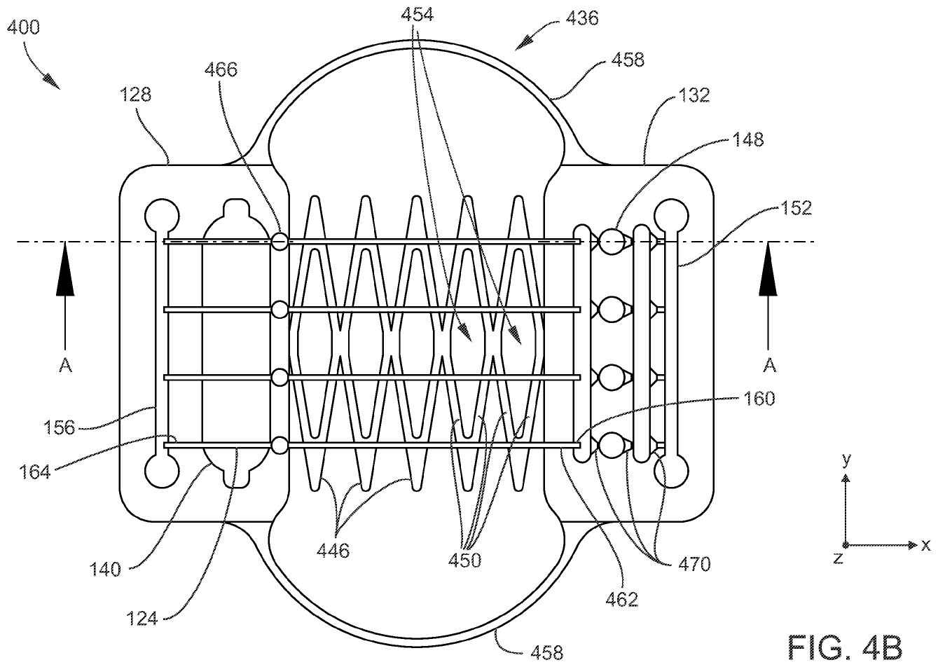

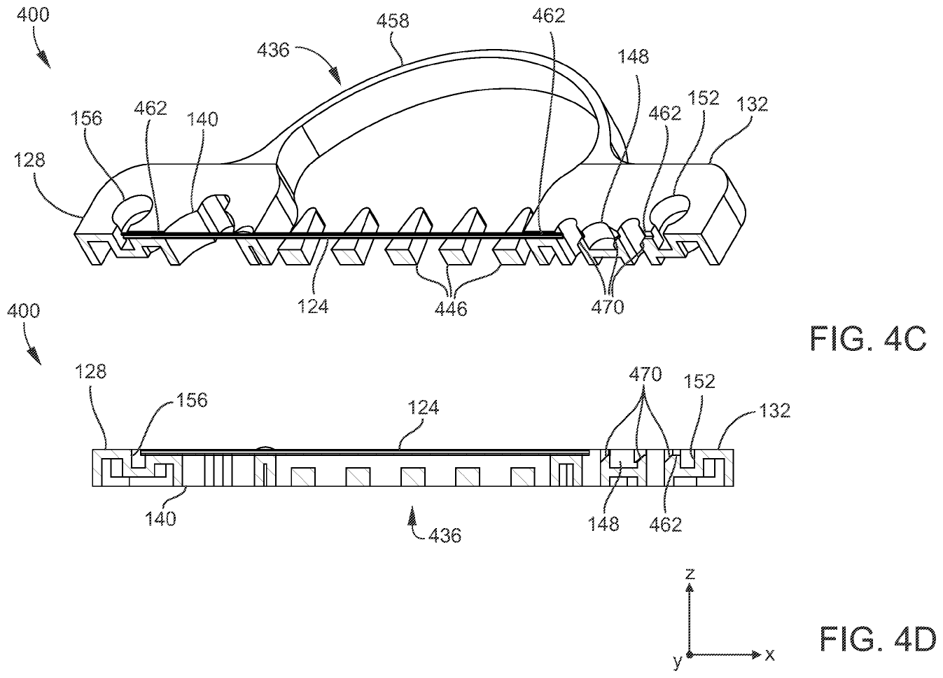

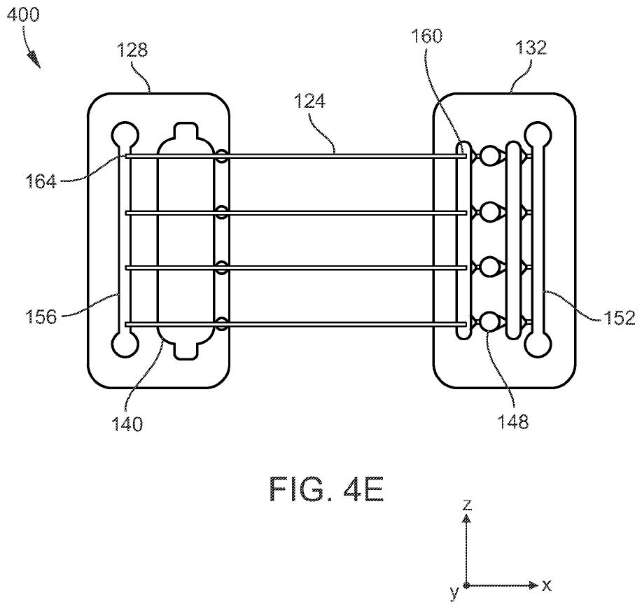

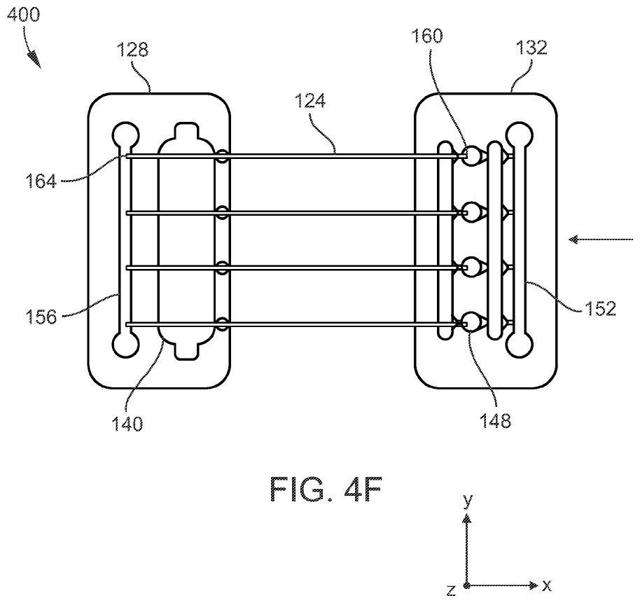

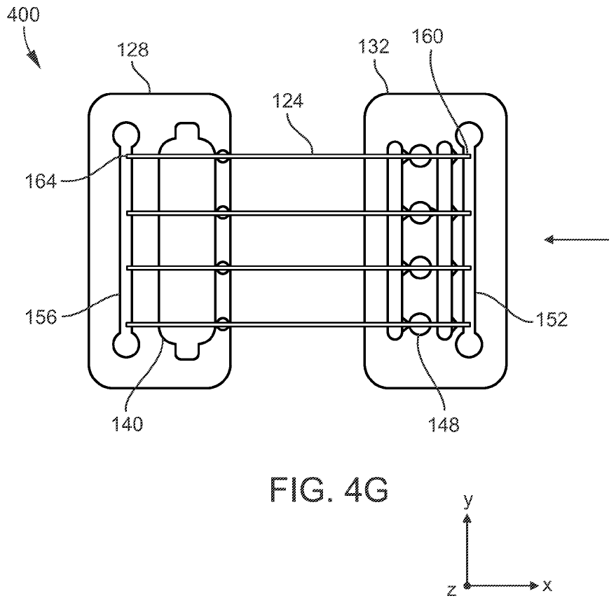

An open frame configuration may be realized by an arrangement (array, pattern, etc.) of open spaces formed in and/or through the solid portion of the flexible section 136. In other words, the open frame configuration may be realized by the body of flexible section 136 being structured to define the arrangement of open spaces. As an example, the flexible section 136 may include an arrangement of holes (openings) passing through the solid portion of the flexible section 136 in one or more directions (x-axis, y-axis, and/or z-axis). The holes may have any size and shape (circular, oval, rectilinear, polygonal, diamond-shaped, etc.) effective for achieving the degree of flexibility needed for a given embodiment. The holes may be defined by an arrangement of “thin” structural members or compliant beams (e.g., a web, mesh, grid, perforated body, etc., formed by ribs, arms, walls, bars, beams, etc.), some of which are integral with each other and some of which are additionally integral with or attached to the stationary section 128 or the movable section 132. In the context of the present disclosure, a “thin” structural member has at least one dimension that is significantly smaller than the length, width, and height of the movable section 132 (or additionally the stationary section 128). As non-exclusive examples, a “thin” structural member may have a width in a certain plane (e.g., the device plane) that is no greater than 20%, or 40%, or 60%, of the length, width, and height of the movable section 132 (or additionally the stationary section 128). Some examples of open frame configurations of the flexible section 136 are described further below in conjunction with FIGS. 4A-6B. In another example, the holes may be open cells distributed throughout the bulk material of the flexible section 136, for example like an open-cell foam or memory foam (e.g., polyurethane (PU) foam or polyethylene terephthalate (PET) foam).

Because the open frame configuration (and compliance of its structural members) renders the flexible section 136 flexible, in such embodiment the flexible section 136 may be composed of a wide variety of materials, and moreover may be composed of the same material as the stationary section 128 or the movable section 132. Such configuration allows the capillary array holder 120 (including the stationary section 128, the movable section 132 and flexible section 136) to be fabricated as a single-piece article with the use of techniques appropriate for the material selected and features to be formed. Examples of materials for the flexible section 136 (or the entire capillary array holder 120) include, but are not limited to, metals (e.g., aluminum, nickel, copper); metal alloys (e.g., stainless steel); silicon; ceramics; glasses; and polymers or plastics. Examples of polymers or plastics include, but are not limited to, polydimethylsiloxane (PDMS); polyoxymethylene (POM); liquid-crystal polymer (LCP); polyacrylamide (PA); polycarbonate (PC); poly(methyl methacrylate) (PMMA); polyether ether ketone (PEEK); polyethylene terephthalate (PET); polyethylene (PE); polystyrene (PS); polymethylmethacrylate (PMMA); polyvinyl chloride (PVC); polypropylene (PP); polyphenylene sulfide (PPS); and mixtures of two or more of the foregoing materials. For example, a mixture may be a two-component polymer mold with conductive carbon-fiber filled segments that are over-molded with an insulating polymer, thereby creating an integrated high-voltage (HV) electrode in a polymer housing.

In other examples of a flexible configuration, the flexible section 136 may not necessarily have an open frame configuration as described above, but may be composed of a material that is inherently highly flexible. In this case, the stationary section 128 and the movable section 132 may be composed of different materials that are less flexible than the material of the flexible section 136. In the present context, the term “highly flexible” is relative to the flexibility of the stationary section 128 and the movable section 132. For example, in response to an applied (actuation) force, the flexible section 136 due to being highly flexible will readily flex (move, with compression and/or expansion/extension), whereas the stationary section 128 and the movable section 132 will not flex (at least to any significant degree). Examples of highly flexible materials for the flexible section 136 include, but are not limited to, metal alloys like spring steel; semi-crystalline polymers like PE, PP, PA, POM, and polybutylene terephthalate (PBT); and amorphous polymers like PC, acrylonitrile butadiene styrene (ABS), PS, and PVC.

In other examples of a flexible configuration, the flexible section 136 may include one or more hinges or other type of component that defines a pivoting axis. Each hinge may couple two subsections of the flexible section 136, thereby allowing one or both of the subsections to pivot about the pivot axis in response to force. For example, the flexible section 136 shown in FIGS. 1A-1C may include one or more hinges having pivot axes in the z-direction.

In other embodiments, the capillary array holder 120 may include an intrinsic actuator. For example, all or part of the movable section 132 and/or flexible section 136 may be an intrinsic actuator, or intrinsically actuating component (i.e., may be composed of an intrinsically actuating material). Similarly, the movable section 132 and/or flexible section 136 may include an intrinsically actuating component that is in abutting contact with or is coupled to a non-intrinsically actuatable component (i.e., a component that is not itself an intrinsic actuator). In other words, in either case, the movable section 132 and/or flexible section 136 may be or include an intrinsically actuating component. Generally, an intrinsically actuating material is a material capable of reversibly changing its shape (or being deformed) in at least one dimension in response to receiving an energetic stimulus (or activation) applied to it, such as an electrical input (voltage, or electrical field), a thermal input (heat), an electromagnetic input (light), or a magnetic input (magnetic field). The specific type and material composition of the intrinsically actuating component may be now known or later developed, such as in the field of “soft” robotics. Examples of intrinsically actuating components include, but are not limited to, dielectric elastomer actuators (DEAs), shape-memory polymers (SMPs), and shape-memory alloys (SMAs).

A DEA may be configured as a compliant, plate-type capacitor, with the body or block of the intrinsically actuating (DEA) material being sandwiched between two planar (plate, layer, film, coating, etc.) electrodes (or, alternatively, two ionic hydrogels such as polyacrylamide hydrogels). The electrodes are coupled to a high-voltage (HV) source, which may be the same HV source utilized for electrophoresis and described herein. In response to application of a high voltage (i.e., high-voltage electric field) between the electrodes, the DEA material becomes strained so that in effect, the DEA material is squeezed (i.e., its thickness is reduced) between the electrodes by electrostatic pressure and concomitantly expanded in the plane parallel to the electrodes. The amount of electrostatic pressure produced depends on the magnitude of the voltage applied, the thickness of the DEA material, and the dielectric constant of the DEA material. Thus, for example, if all or part of the movable section 132 and/or flexible section 136 is composed of the DEA material, the DEA material and accompanying electrodes may be positioned and oriented such that application of the high voltage causes the movable section 132 and/or flexible section 136 to contract (shrink) along the device axis. In another example, if the DEA component is separate from (but in contact or coupled with) the movable section 132 and/or flexible section 136 (or, equivalently, the movable section 132 and/or flexible section 136 includes the DEA component as well as a non-intrinsically actuatable component), the DEA component (DEA material and accompanying electrodes) may be positioned and oriented such that the electric field-induced contraction or shrinkage causes the DEA component to push or pull the movable section 132 and/or flexible section 136 along the device axis. Examples of DEA materials include, but are not limited to, acrylic elastomers (e.g., the VHB 4910 elastomer commercially available from 3M, St. Paul, Minnesota, USA), silicones (e.g., PDMS), and natural rubbers (e.g., polyisoprene elastomers, or latex).

In a typical example, an SMP may be pre-strained (pre-stretched) to a deformed shape by application of heat energy, in particular heating the SMP to a temperature above its glass transition temperature or melting transition temperature, and then cooled down to retain the deformed shape. Subsequently, in response to another application of heat energy, the deformed SMP will revert back to its original (non-deformed) shape due to the strain being released. Thus, like a DEA component, if all or part of the movable section 132 and/or flexible section 136 is composed of an SMP material, an SMP component may be positioned and oriented such that the application of heat energy changes the deformed movable section 132 and/or flexible section 136 back to its or their original shape(s). Alternatively, if the SMP component is separate from (but in contact or coupled with) the movable section 132 and/or flexible section 136 (or, equivalently, the movable section 132 and/or flexible section 136 includes the SMP component as well as a non-intrinsically actuatable component), the SMP component may be positioned and oriented such that the heat-induced shape change causes the SMP component to push or pull the movable section 132 and/or flexible section 136 along the device axis. Examples of heat-activated SMP materials include, but are not limited to, polyurethane (PU), polyethyleneoxide (PEO), PS, PET, and PEEK. One or more of these polymers may be provided as a block copolymer with one or more other polymers, as appreciated by persons skilled in the art. Another example of a heat-activated SMP material is polynorbornene, which may or may not be provided in the form of an organic-inorganic hybrid polymer in which some of the polynorbornene units are substituted by polyhedral oligomeric silsesquioxane (POSS).

In addition to heat-activated SMPs, the SMP component instead may be a light-activated SMP. In this case, the shape of the SMP will be deformed in response to irradiation by light (e.g., UV light) of a first wavelength. Subsequently, the SMP is returned to its original shape in response to irradiation by light of a different, second wavelength. Examples of light-activated SMP materials include, but are not limited to, cinnamic acid and cinnamylidene acetic acid, and more generally polymers containing cinnamic groups.

In another example, the SMP component may be an electro-activated SMP. In this case, the shape of the SMP will be deformed in response to application of a voltage (electric field) of an appropriate magnitude. An electro-activated SMP may be rendered electrically conductive by including an electrically conductive filler in the polymer material such as, for example, carbon nanotubes (CNTs), carbon fibers, carbon black, or a metallic (e.g., nickel, Ni) powder.

In another example, the SMP component may be a magneto-activated SMP. In this case, the shape of the SMP will be deformed in response to application of a magnetic field. A magneto-activated SMP may be rendered magnetically responsive by including a magnetic filler in the polymer material such as, for example, magnetite or certain metallic (e.g., Ni) particles or fibers.

An SMA may be deformed while in a cold (unheated) state, and subsequently returned to its original shape by application of heat energy. Like with other shape-memory materials, this cycle is reversible. Typically, the SMA component is configured to be compliant or spring-like, such as by being formed as a thin wire. Examples of SMA materials include, but are not limited to, nickel-based alloys (e.g., Ni—Ti, Ni—Ti—Hf, Ni—Ti—Pd, Ni—Fe—Ga, Ni—Mn—Ga, Ni—Mn—Ga—X (where X=Cu, Co, or Fe)); copper-based alloys (e.g., Cu—Al—Ni, Cu—Al—Ni—Hf, Cu—Sn, Cu—Zn, Cu—Zn—X (where X=Al, Si, or Sn), Cu—Al—Be—X (where X=Zr, B, Cr, or Gd)); iron-based alloys (e.g., Fe—Mn—Si, Fe—Pt. Fe—Pd); silver-based alloys (Ag—Cd); gold-based alloys (Au—Cd), cobalt-based alloys (Co—Ni—Al, Co—Ni—Ga); manganese-based alloys (Mn—Cu), and titanium-based alloys (Ti—Nb). Depending on the composition of the alloy, some of these SMAs may additionally be magnetic SMAs (MSMA), also known as a ferromagnetic SMAs (FSMAs), which are able to change shape in response to application of a magnetic field as an alternative to heating. Examples of MSMA materials include, but are not limited to, the above-noted Ni—Mn—Ga based alloys, Ni—Fe—Ga, and Fe—Pd.

In typical (but not exclusive) embodiments, the capillary array holder 120 is sized as a miniaturized chip. In the present context, “miniaturized” is taken to mean that the dimensions (length, width, and height) of the capillary array holder 120 are on the order (or scale) of millimeters (mm), i.e., generally in a range from a fraction of 1 mm to 1000 mm (1 meter (m)). In one example, the axial length of the capillary array holder 120 is in a range from 30 mm to 130 mm.

Generally, any technique appropriate for the material utilized (e.g., organic polymer, metal, metalloid, etc.) and the sizes of the components may be employed for fabricating/manufacturing the capillary array holder 120. The specific fabrication technique implemented should be one highly suitable for forming the flexible section 136 according to the configurations described herein. Generally, various techniques for fabrication of miniaturized articles, including techniques utilized in the fields of microfluidics or microelectronics, may be suitable for fabrication the capillary array device 100. In the case of a polymer or plastic, examples of manufacturing techniques include, but are not limited to, micro-injection molding and 3D printing. In the case of a metal or metalloid, various additive, subtractive, and formative manufacturing techniques may be employed. Examples of additive techniques include, but are not limited to, 3D printing (e.g., lithography-based metal manufacturing (LMM)), galvanoforming, electroforming or electrodeposition, chemical vapor deposition (CVD), and physical vapor deposition (PVD). Examples of subtractive techniques include, but are not limited to, dry etching (e.g., plasma-based etching, including reactive ion etching (RIE) and deep reactive ion etching (DRIE), etc.), wet etching (i.e., chemical etching, such as by using hydrofluoric acid or other acid) and subsequent diffusion bonding, micromachining, micro-milling, micro-laser machining, and micro-electrical discharge machining (EDM). Examples of formative techniques include, but are not limited to, micro stamping, micro embossing, and LIGA (German: Lithographic, Galvanoformung, Abformung).

In typical (but not exclusive) embodiments, the capillaries 124 are composed of an optically transparent material. In the context of this disclosure, an “optically transparent” material is a material that allows transmission of light propagating at wavelengths in a range that includes (at least) the wavelength or wavelengths of excitation light EX and emission light EM (described further below, and see FIG. 1F) employed in the use of the capillary array device 100. Depending on the embodiment, the excitation light EX and/or emission light EM may be ultraviolet light, visible light, or infrared light. Examples of the material of the capillaries 124 include, but are not limited to, silica, fused silica, fused quartz, doped (synthetic) fused silica, and polymers such as polytetrafluoroethylene (PTFE) (e.g., for UV detection). A portion (e.g., majority) of the length of each capillary 124 may be coated, i.e., circumferentially surrounded by a coating. The coating may serve to protect the capillary 124 from damage or breaking, and also to block the transmission of light into and out from the capillary 124. Examples of the material of the coating include, but are not limited to, polyimide (PI), acrylate, silicone, and fluoropolymers. If coated, at least one section of each capillary 124 is barc (is not coated) such that the barc (or exposed, or uncoated) section, referred to as a “capillary window,” is exposed to the ambient and thus allows transmission of light into and out from the capillary 124. The capillaries 124 may be fabricated by any appropriate technique now known or later developed. As an example, the capillaries 124 may be fabricated by first forming the tube portions (including the lumens), then coating the entire lengths of the capillaries 124, and then stripping the coating from sections of the capillaries 124 to form the capillary windows.

In the context of this disclosure, excitation light EX may refer to a beam (or ray) of light directed from a light source external to the capillary array device 100 to the capillaries 124 (or to the windows of the capillaries 124, if provided) to thereby irradiate samples residing in the respective capillaries 124. The beam of excitation light EX may or may not be coherent, depending on the embodiment. Such light source may be part of an analytical instrument configured to perform an optical-based measurement on analytes in the samples to determine a property or attribute (e.g., concentration of one or more analytes), and/or to acquire a microscopic image, etc., as appreciated by persons skilled in the art. Emission light EM may refer to light emitted from each capillary 124 (or window thereof) in response to the incident excitation light EX, which may be collected (or captured) by a detector (or camera) of the analytical instrument. In some embodiments, emission light EM may result from a different type of stimulus, such as a chemical reagent, in which case excitation light EX may not be required.

In some examples, the excitation light EX may be utilized to illuminate the sample in the capillary 124 to measure absorbance (or transmittance) and/or to acquire a microscopic image. In other examples, the excitation light EX of a selected wavelength may be utilized to “excite” target analytes in the sample in the capillary 124 by inducing fluorescence (e.g., from an inherently fluorescent analyte, or from a fluorophore added or bound to an analyte, etc.) or similarly phosphorescence. For convenience, the term “excitation” is used herein to refer to all such cases, including illumination not involving fluorescence or phosphorescence. In the example of acquiring an image, the emission light EM is the light emitted from the capillary 124 within the field of view of a camera, which is processed as needed to construct an image of the sample in the capillary illuminated by the excitation light EX. In the example of measuring absorbance (or transmittance), the emission light EM emitted from the capillary 124 is attenuated due to partial absorbance of the excitation light EX by the sample in the capillary 124. In such case, the omission light EM may be of the same wavelength as the excitation light EX but may have a lower intensity. In the example of measuring fluorescence, the emission light EM is the light emitted from analytes responsive to the wavelength of the excitation light EX. In such case, the emission light EM is of a different wavelength than the excitation light EX. Another example is fluorescent microscopy, in which the captured images are based in part on fluorescent emission. For convenience, the term “emission” is used herein to refer to all such cases, including the transmission of non-fluorescent light.

In typical (but not exclusive) examples, the axial length of the capillaries 124 is on the order of millimeters (as defined above), and the outer diameter of the capillaries 124 is on the order of micrometers (μm), i.e., generally from a fraction of 1 μm to 1000 μm (1 mm). In an example, the length of the capillaries 124 is in a range from 20 mm to 120 mm. In an example, the outer diameter of the capillaries 124 is 80 μm to 200 μm (e.g., hollow fused silica tubing with no protective jacket), or 150 μm to 900 μm (e.g., fused silica core with protective jacket) with one specific example being 80 μm. The capillaries 124 are arranged side-by-side along the transverse axis, typically with a uniform spacing. In one example, the spacing between adjacent capillaries 124 along the transverse axis is in a range from 1 mm to 10 mm. In another example, the capillaries 124 may be spaced in a more compact packaging, but cross-talk effects may cause problems with increased background and ghost peaks. A concept to mitigate those negative effects while allowing a more compact packaging is described in International Application No. PCT/US2021/044806, filed on Aug. 5, 2021, and titled “CAPILLARY ARRAY WINDOW HOLDER AND RELATED SYSTEMS AND METHODS,” the entire contents of which are incorporated by reference herein. In an example where the capillaries 124 include capillary windows, the axial length of the capillary windows is in a range from 500 μm to 4 mm (4000 μm).

In the example illustrated in FIG. 1A, the capillary array holder 120 includes one stationary section 128, one movable section 132, and one flexible section (or flexible coupling) 136 interposed between the stationary section 128 and the movable section 132 relative to the device axis. The capillaries 124 may be configured as detection cells to contain samples that are detected/measured by an associated analytical instrument. In some embodiments, the samples flow through the capillaries 124 in a direction along the device axis during the optical detection/measurement step, in which case the capillaries 124 serve as flow cells. For these purposes, the capillary array holder 120 may include a detection area 140 extending through the height (thickness) of the capillary array holder 120, i.e., from a top surface 144 to a bottom surface 148 (FIG. 1D) of the capillary array holder 120. The detection area 140 is configured to allow transmission of emission light EM out from the detection area 140, or additionally to allow transmission of excitation light into the detection area 140 (see FIG. 1F). If the capillaries 124 are coated and provided with windows as described above, the capillaries 124 are mounted to the capillary array holder 120 such that the detection area 140 spans (at least a majority of) the length of the overlying windows. In some embodiments, the detection area 140 is part of the stationary section 128, which may facilitate ensuring optical alignment of the detection area 140 with the optical system of the analytical instrument. Alternatively, the detection area 140 may be part of the movable section 132.

The capillary array device 100 may be mounted to any suitable analytical instrument configured to make optical-based measurements on analytes contained in the capillaries 124. Depending on the embodiment, the capillary array device 100 may be loaded directly in a housing or console of the analytical instrument and positioned in alignment with the optical system of the analytical instrument, or may be configured as part of an assembly or cassette that is loaded in the housing or console. For example, the capillary array holder 120 may include one or more mounting features configured to engage a device support, which in turn is configured to engage a receptacle of the analytical instrument, particularly so that the capillaries 124 are properly optically aligned with the optical system of the analytical instrument, etc.

In some embodiments, capillary array device 100 integrally includes containers. Depending on the embodiment, some containers may serve as sources of liquids and/or gels to be loaded (introduced, or injected) into the capillaries 124, while other containers may serve as receptacles that receive liquids and/or gels exiting the capillaries. As examples, a liquid may be a sample-containing solution, a buffer solution, a reagent, a liquid containing a label (e.g., dye, fluorophore, etc.), etc.; and a gel may be a separation medium formulated for electrophoresis or chromatography. The containers may be formed in the top surface 144 of the capillary array holder 120 (i.e., the top surfaces of the stationary section 128 and/or the movable section 132). Examples of containers include wells and troughs.

In the illustrated example, the movable section 132 includes a linear (one-dimensional) array of wells 148 positioned (spaced along the transverse axis) such that each capillary 124 is aligned with a respective one of the wells 148 along the device axis. The movable section 132 also includes a first trough 152 extending along the transverse axis. Additionally, the stationary section 128 includes a second trough 156 extending along the transverse axis. The first trough 152 and the second trough 156 have widths that are greater than the transverse distance spanned by the array of capillaries 124. In this way, the first trough 152 and the second trough 156 are wide enough along the transverse axis to receive all of the capillaries 124 simultaneously. The wells 148 are useful for containing individual samples or other liquids for which mixing or cross-contamination is not desired, thereby facilitating analyses of the samples separately in corresponding capillaries 124. Movement of liquids or gels between adjacent wells 148 is restricted (and preferably entirely prevented) due to the dedicated capillary/groove/well geometry (i.e., adequately separated channels) and also due to surface tension, particularly in the case of a small-scale or miniaturized configurations where surface tension may play a significant role in the fluid mechanics of the capillary array device 100. The troughs 152 and 156 are useful for supplying the same liquid or gel to all capillaries 124, or for receiving the outputs of all capillaries 124 when such outputs do not need to remain separated from each other.

In the illustrated example, the capillaries 124 are movable into and out from the respective wells 148 in response to movement of the movable section 132 (movement to the left, from the perspective of FIG. 1A). The capillaries 124 are further movable into and out from the first trough 152 in response to further movement of the movable section 132 (further movement to the left). More specifically, each capillary 124 has a first capillary end 160 and an axially opposing second capillary end 164. The first capillary ends 160 are movable into and out from the respective wells 148 and the first trough 152. In this example, the wells 148 are positioned closer to the capillaries 124 than the first trough 152. Hence, as the movable section 132 moves toward the capillaries 124 (to the left), the first capillary ends 160 will first access the wells 148 before accessing the first trough 152. Also in this example, the second trough 156 is positioned relative to the fixed position of the capillaries 124 such that the second capillary ends 164 are permanently disposed in the second trough 156.

In other embodiments, the second trough 156 may be located on a movable section of the capillary array holder 120, which may be in addition to the illustrated movable section 132. In other embodiments, the movable section 132 (and/or additional movable section(s)) may include additional wells and/or troughs, depending on the application.

In the present example, FIG. 1A shows the capillary array device 100 in a first (or initial) position. At the first position, the movable section 132 has not been moved (e.g., actuated), and thus the flexible section 136 is relaxed (is not flexed). The first position may also correspond to a storage position, i.e., the state in which the capillary array device 100 is stored or initially provided to a user before use. The first position may also correspond to a capillary loading position. That is, a liquid or gel may be dispensed into the second trough 156. The liquid or gel is then loaded into the capillaries 124 via the second capillary ends 164. In the present example, the liquid or gel may be passively loaded into the capillaries 124 by capillary action (or wicking), as appreciated by persons skilled in the art. Depending on the amount dispensed into the second trough 156 and the period of time allotted for the loading, the lumens (inner bore) of the capillaries 124 may be partially or entirely filled with the liquid or gel in this manner. Accordingly, the capillary array device 100 does not require an active fluid moving device (e.g., a positive displacement pump such as a syringe, or a vacuum pump, etc.) to load the capillaries 124 with liquids or gels. In some applications, however, the loading of certain liquids or gels may be done electrokinetically, as described below.

FIG. 1B shows the capillary array device 100 in a second position. The capillary array device 100 has been moved from the first position to the second position by moving (e.g., actuating) the movable section 132, as indicated by a leftward-pointing arrow in FIG. 1B. The movement of movable section 132 causes the flexible section 136 to flex. By way of example, FIG. 1B schematically depicts the flexing of the flexible section 136 as involving an axial compression of the flexible section 136 (or a squeezing of the flexible section 136 between the stationary section 128 and the movable section 132), and an outward extending or bulging of the flexible section 136 in either direction along the transverse axis, as indicated in part by an upward-pointing arrow and a downward-pointing arrow in FIG. 1B. Various portions or structural members of the flexible section 128 may move in various directions as part of the flexing response, in which case the outward transverse directions shown in FIG. 1B may be the predominant directions of the flexing or movement. The flexing of the flexible section 136 changes the overall axial length of the capillary array holder 120, and thus also the overall axial length of the capillary array device 100. In the present example, the flexing of the flexible section 136 reduces the overall axial length of the capillary array holder 120.

At the second position, the movable section 132 has been moved (linearly translated along the device axis) far enough (to the left in FIG. 1B) that the first capillary ends 160 are now disposed in the corresponding wells 148. The distance of movement required for the first capillary ends 160 to reach the wells 148 may vary, depending on the embodiment. As non-limiting examples, the distance may be one or more tens of millimeters, or just a few millimeters (e.g., 2-5 mm). At the second position, any liquids or gels contained in the wells 148 can be passively loaded into the capillaries 124 by capillary action through the first capillary ends 160. The liquid or gel may be dispensed into the wells 148 before moving the first capillary ends 160 into the wells 148, in which case the liquid or gel will be drawn into the capillaries 124 upon moving the first capillary ends 160 into the wells 148. Alternatively, the liquid or gel may be dispensed into the wells 148 after moving the first capillary ends 160 into the wells 148, in which case the liquid or gel will be drawn into the capillaries 124 upon dispensing the liquid or gel into the wells 148. Depending on the application, at the second position, the second trough 156 may serve as a receptacle for collecting any liquid or gel that exits the second capillary ends 164.

FIG. 1C shows the capillary array device 100 in a third position. The capillary array device 100 has been moved from the second position to the third position by further moving (e.g., actuating) the movable section 132, as indicated by a leftward-pointing arrow in FIG. 1C. That is, the movable section 132 has been linearly translated further along the device axis, which in this example means further to the left in comparison to FIG. 1B. This further movement causes further flexing of the flexible section 136, as indicated in part by an upward-pointing arrow and a downward-pointing arrow in FIG. 1C, and further shortening of the overall axial length of the capillary array holder 120. At the third position, the movable section 132 has been moved far enough (beyond the wells 148) that the first capillary ends 160 are now disposed in the first trough 152. As with the second position, if the first trough 152 contains a liquid or gel, that liquid or gel now may be passively loaded into the capillaries 124 by capillary action through the first capillary ends 160. Alternatively, depending on the application, at the third position, the first trough 152 may serve as a receptacle for collecting any liquid or gel that exits the first capillary ends 160.

FIGS. 1A-1C depict the state of the flexible section 136 at the first, second, and third positions, respectively, in a schematic way. The exact type of response of the flexible section 136 to the movement of the movable section 132 depends on the specific configuration of the flexible section 136. As described above and further below, many different configurations for the flexible section 136 are possible and are encompassed by the present disclosure. In FIGS. 1A-1C, the lines depicting the boundaries of the flexible section 136 do not necessarily represent continuous or solid walls or edges. Instead, depending on the flexible configuration, these lines may represent the outer envelope of the three-dimensional space occupied by the flexible section 136 at the first, second, and third positions.

In some examples, all or part of the flexible section 136 is configured as a compliant spring that imparts a biasing force directed toward the movable section 132, i.e., in the axial direction opposite to the axial direction in which the movable section 132 translates (biasing to the right in FIGS. 1A-1C) from the first position to the second and third positions. Hence, the flexible section 136 may bias the capillary array device 100 into the first position shown in FIG. 1A in the absence of a force applied to the movable section 132. In this case, when it is desired to move the movable section 132 to the second position shown in FIG. 1B or the third position shown in FIG. 1C, the force applied to the movable section 132 will be large enough the overcome the biasing force of the flexible section 136. Once the second or third position is no longer needed, the force applied to the movable section 132 may be removed. Consequently, the biasing force moves the movable section 132 back to the first position (i.e., the nominal or default position), without needing to actively push or pull the movable section 132 back to the first position.

The specific use and sequence of movements of the capillary array device 100 depend on the specific application for which the capillary array device 100 is being utilized. At one or more periods of time during the use of the capillary array device 100, one or more of the first, second, and third positions may be utilized one or more times. Also at one or more periods of time during the use of the capillary array device 100, optical measurements of the samples in the capillaries 124 may be made by an appropriate analytical instrument in/on which the capillary array device 100 has been mounted or installed, as appreciated by persons skilled in the art. Such measurements may involve the transmission of light from, or both to and from, the detection area 140 provided with the capillary array holder 120.

Generally, liquids or gels may be dispensed into (supplied or delivered to) the wells 148, first trough 152, and the second trough 156 by any suitable technique, which may be manual or automated. For example, a user may manually dispense a liquid or gel by using an appropriate dispensing device such as a pipette, syringe, or the like. As another example, the capillary array device 100 may be loaded into an instrument that has an automated liquid/gel handling system, as appreciated by persons skilled in the art. In such a system, reservoirs (e.g., bottles) containing a supply of liquids or gels may be coupled to liquid/gel lines that are in turn coupled to one or more pumps and a dispensing device, which may be movable in an automated manner such as a motor-driven pipette head. However, the ability to manually supply liquids and gels to the capillary array device 100 may be considered to be advantageous in many applications, as it avoids the need for an automated liquid/gel handling system.

The capillary array device 100 may be provided as a “consumable” article of manufacture, e.g., as a single-use device. That is, the capillary array device 100 may be disposable after use. For example, the capillary array device 100 may be utilized to load samples into the capillaries 124 once and subsequently perform a single analytical run on those samples. In other words, the capillary array device 100 may be utilized for a single iteration of the capillary loading and analytical run steps. Thereafter, the capillary array device 100 may be discarded, and a new (fresh) capillary array device 100 may be utilized for additional analytical runs on additional samples. The consumable aspect, or disposability, of the capillary array device 100 eliminates the requirements for cleaning, rinsing, washing, or purging of the capillary array device 100, and eliminates any risk of cross-contamination of capillary array device 100 between separate, different analytical runs.

FIG. 1D is a longitudinal side elevation view (along the device axis) of the capillary array device 100, shown coupled to an actuator (assembly) 168 according to an embodiment. The actuator 168 may include an actuating device (or stimulator or activator) 172 of a known type such as a stepper motor, solenoid, etc., and a mechanical link 176 (e.g., an actuator arm, plunger, etc.) coupled to the actuating device 172. The actuating device 172 is configured to linearly translate the mechanical link 176 along the device axis, as indicated by a double-headed arrow in FIG. 1D. The movable section 132 may include one or more features configured to be coupled to or engaged with, or at least be contacted by, the actuator 168 (or, more specifically, the mechanical link 176). In the illustrated example, the movable section 132 (e.g., at its underside) includes, or is attached or mounted to, a stage or platform 180 that is configured to be coupled to or contacted by the mechanical link 176. In another example, an axial end surface 184 of the movable section 132 is configured to be coupled to or contacted by the mechanical link 176. For creating a mechanical coupling between the movable section 132 and the mechanical link 176, any suitable coupling arrangement may be provided, as appreciated by persons skilled in the art. Examples of coupling arrangements include, but are not limited to, a snap fit arrangement (e.g., the mechanical link 176 snaps into a recess of the movable section 132), an abutting arrangement (e.g., respective surfaces of the movable section 132 and the mechanical link 176 engage to enable the mechanical link 176 to push the movable section 132 toward the flexible section 136, or additionally to pull the movable section 132 back away from the flexible section 136 if the flexible section 136 is not spring-biased), a fastening arrangement (e.g., using fastening components such as clamps, spring clips, screw threads, etc.), a magnetic coupling arrangement (e.g., the movable section 132 and the mechanical link 176 include magnets oriented to attract each other), etc.

In another example, the movable section 132 and the mechanical link 176 may be coupled in a non-contacting fashion. For example, the movable section 132 and the mechanical link 176 (or the actuating device 172 itself, without a mechanical link 176) may include magnets oriented to repel each other, such that movement of the mechanical link 176 toward the movable section 132 repels the movable section 132 toward the flexible section 136. In the present context, a “magnet” may be a permanent magnet or an electromagnet. If at least one of the magnets (of the movable section 132, or the mechanical link 176 or actuating device 172) is an electromagnet, then the magnetic field may be controlled by electrical current supplied to the electromagnet. In this case, a mechanical link 176 may not be required, or at least the mechanical link 176 may not be required to move toward and away from the movable section 132.

In another example, actuation may be performed manually by a user. In this case, one or more of the elements 172, 176, and 180 in FIG. 1D may represent a lever, handle, or other component manipulated by the user.

In the examples just described in conjunction with FIG. 1D, the actuator 168 may be referred to as an extrinsic actuator to distinguish it from the intrinsic actuators described earlier in this disclosure. An extrinsic actuator often relies on making physical (or mechanical) contact between the actuating device (or stimulator or activator) 172 and the movable section 132, thus cooperating with some type of mechanical link 176 as just described. Hence, an extrinsic actuator is often a “contacting” actuator, with at least one exception being the above-noted example of utilizing repelling magnets. In other examples, the actuator 168 may be an intrinsic actuator, in which at least a portion of the movable section 132 and/or flexible section 136 is considered as including the intrinsically actuating component as described earlier in this disclosure. When the actuator 168 is configured as an intrinsic actuator, the actuating device (or stimulator or activator) 172 may be a voltage source (e.g., as part of electrical circuitry), a heat source (e.g., a resistive-type heating device that generates Joule (ohmic) heating), a light source (e.g., a lamp, light-emitting diode (LED), laser, laser diode (LD), etc., configured to emit electromagnetic energy at an appropriate wavelength), or a magnetic source (e.g., one or more magnets). In a case where an intrinsic actuator is provided, the link (or coupling) between the actuating device 172 and the intrinsic actuator may be either an electrical interconnect (wiring and electrodes) or a “non-contacting” (or wireless) link such as heat energy or electromagnetic energy (e.g., light beam) propagating though the air, or a magnetic field.

FIG. 1E is a longitudinal side elevation view of the capillary array device 100, shown coupled to an electrical circuit according to an embodiment. In particular, the capillary array device 100 is coupled to a high-voltage (HV) source 188. In this example, the capillary array device 100 includes electrodes 192 positioned in one or more of the wells 148, the first trough 152, and the second trough 156. The electrodes 192 may be placed in electrical communication with the HV source 188 (and any associated electrical circuitry) via appropriate electrical interconnections such as electrical wiring; electrical contacts; liquid-tight electrical feed-throughs or “vias” formed through the body of the capillary array holder 120 below or to the side of the wells 148, first trough 152 and/or second trough 156; etc., as appreciated by persons skilled in the art. The electrodes 192 may be provided and electrically coupled to the HV source 188 as needed for a given application. In particular, the electrical configuration may be utilized to apply a voltage (potential difference) across the lengths (between the first and second axial ends 160 and 164) of the capillaries 124. For example, electrodes 192 located in the wells 148 and/or first trough 152 may serve as anodes, and the electrode 192 located in the second trough 156 may serve as a cathode. The applied voltage may be utilized to assist in loading a liquid into the capillaries 124 and/or to transport the liquid through capillaries 124 by an electrokinetic force. In some examples, the applied voltage is utilized as part of performing electrophoresis on samples in the capillaries 124 (particularly, capillary electrophoresis or CE), as described elsewhere herein. As one example, the applied voltage may be in a range from 0.2 kV to 5 kV.

In an example, one or more of the electrodes 192 also may be utilized to generate an electric field that stimulates (activates) an electro-activated intrinsic actuator as described above.

In the embodiment of FIG. 1E, the wells 148 do not need to be coupled in common with the HV source 188, but instead the wells 148 may be addressable individually by the HV source 188. For example, appropriate switches 196 may be provided in the electrical circuitry between the HV source 188 and each of the electrodes 192 in the corresponding wells 148. By this configuration, a voltage may be applied selectively to any one or more of the capillaries 124, and may be applied according to a predetermined sequence if called for by the method protocol. Moreover, the voltage may be applied one or more times to one or more selected capillaries 124 according to a predetermined pulse width or widths, pulse shape or shapes, and sequence of pulses.

FIG. 1F is a longitudinal side elevation view of the capillary array device 100, shown coupled to an optics-based measurement device (or system) 106 according to an embodiment of the present disclosure. The optics-based measurement device 106 may be configured and may function according to any technique, now known or later developed, appropriate for analyzing samples in capillaries 124. In typical examples, the optics-based measurement device 106 includes a light source 110 and a light detector (or camera) 114. The light source 110 (and any associated excitation optics needed) is configured to generate and direct an excitation light beam EX to the portions of the capillaries 124 located at the detection area 160 (which may be capillary windows as described above). The light detector or camera 114 (and any associated emission optics needed) is configured to receive or capture emission light beams EM emitted from the portions of the capillaries 124 located at the detection area 160. As illustrated, sample excitation and detection may be both performed on the same side of the capillary array device 100, such as the top side as illustrated. Alternatively, the optics-based measurement device 106 may be configured for through-illumination, by which sample excitation and detection are performed on opposite sides of the capillary array device 100 (e.g., the light source 110 may be positioned above, and the light detector or camera 114 may be positioned below, the capillary array device 100, or vice versa). If needed, an appropriately configured light trap (or “beam dump”) 118 may be positioned to capture or absorb stray excitation light and/or emission light. In some applications, the excitation or stimulation of the samples may be done by means other than an optical beam, such as by chemical reaction, in which case the light source 110 may be omitted or at least not utilized in such application.

In an embodiment, the capillary array device 100 is configured for capillary electrophoresis (CE), i.e., is configured to carry out CE runs on samples in the capillaries 124. In this case, and in the example illustrated in FIGS. 1A-1F, the wells 148 may be utilized as sample wells configured to contain individual samples (e.g., volumes of sample solutions) on which analytical separation by CE is desired. The first trough 152 may be utilized as a buffer trough configured to contain an appropriate buffer solution. The buffer solution functions as an electrolytic solution (i.e., as a source of ions) capable of conducting electrical charges, and may be formulated to perform other functions such as pH control. The second trough 156 may be utilized as a gel trough configured to contain a CE separation medium, which usually is provided in the form of a polymer gel that may be solid yet porous. The specific type and composition of the CE separation medium depends on the type of analytes to be separated, as appreciated by persons skilled in the art. Examples of a CE separation medium include, but are not limited to, polyacrylamide, agarose, and certain starches.

A method for analyzing a sample by CE will now be described. The method utilizes a capillary array device configured for CE and in accordance with any of the embodiments or examples described herein, such as the capillary array device 100 described above and illustrated in FIGS. 1A-1F. According to the method, the capillary array device 100 is initially provided in the first position shown in FIG. 1A, which may be referred to as the gel loading position. The second trough 156 (gel trough) is filled with a desired amount of the CE separation medium. The amount of CE separation medium dispensed into the second trough 156 may depend on the specific method protocol being implemented, which may in turn depend on the number and length of the capillaries 124 and whether the capillaries 124 are to be entirely or partially filled. Next, because the second capillary ends 164 are already positioned in the second trough 156, the CE separation medium is passively loaded (or drawn) into the capillaries 124 by capillary action. Before or after loading the CE separation medium into the capillaries 124, the wells 148 (sample wells) are filled with individual samples (which may be the same or different from each other in terms of composition), and the first trough 152 (buffer trough) is filled with a buffer solution.

Next, the capillary array device 100 is moved to the second position shown in FIG. 1B, which may be referred to as the sample injection position. Specifically, the movable section 132 is actuated to move in the direction of the flexible section 136, relative to the (stationary) capillaries 124 and the stationary section 128, until the first capillary ends 160 enter the wells 148. With the first capillary ends 160 now positioned in the wells 148, the samples are then loaded into the capillaries 124. At the second position, an electrical circuit with the HV source 188 (FIG. 1E) and the electrodes 192 of the wells 148 and the second trough 156 is completed, due to the electrolytic properties of the liquid and gel in the capillaries 124, wells 148, and second trough 156. Accordingly, a voltage can now be applied across the lengths of the capillaries 124. In particular, a voltage pulse can be applied to electrokinetically inject the samples as sample plugs into the front regions of the capillaries 124. In some examples, this electrokinetic assistance may be needed to due to the flow resistance presented by the gel-phase CE separation medium residing in the capillaries 124.

Next, the capillary array device 100 is moved to the third position shown in FIG. 1C, which may be referred to as the CE run position. Specifically, the movable section 132 is actuated to move further in the direction of the flexible section 136, relative to the (stationary) capillaries 124 and the stationary section 128. During this movement, the first capillary ends 160 pass through the wells 148 and enter the first trough 152. At the third position, an electrical circuit with the HV source 188 (FIG. 1E) and the electrodes 192 of the first trough 152 and second trough 156 is completed, due to the electrolytic properties of the liquid and gel in the capillaries 124, first trough 152, and second trough 156. A voltage is then applied to the capillaries 124 according to predetermined operating parameters (e.g., magnitudes (constant and/or varying or ramping); overall time duration of applied voltage; pulse widths, pulse shapes (e.g., square, triangular, sinusoidal, etc.), and pulse sequence (including pulse frequency)) effective for inducing electrophoretic separation of different analytes of the samples in each capillary 124 in a manner appreciated by persons skilled in the art. Briefly, in each capillary 124, different analytes of the sample migrate under the influence of the applied voltage through the CE separation medium at different speeds, and thereby become separated from each other along the length of the capillary 124. The separated analytes in each capillary 124 may then be detected/measured at the detection area 140 by the optics-based measurement device 106 (FIG. 1F). Subsequently, after acquiring the CE data from the samples, the capillary array device 100 may be discarded in some embodiments, as described above.

The present disclosure also encompasses a sample analysis system (or apparatus, analytical instrument, etc.) that includes an actuator and/or HV source (and associated electrical circuitry) and/or optics-based measurement device, such as the actuator 168, HV source 188, and optics-based measurement device 106 described above and illustrated in FIG. 1D, FIG. 1E, and FIG. 1F, respectively. In an embodiment, the actuator 168, the HV source 188, and the optics-based measurement device 106 may be integrated in a housing or console of the sample analysis system. The sample analysis system may or may not be portable. In practice, the capillary array device 100 may be mounted or installed in or to the sample analysis system. Depending on the application or embodiment, this installation may involve one or more of: mounting the stationary section 128 in a fixed position in which the capillary array device 100 (particularly the detection area 140) is properly aligned with the optics of the optics-based measurement device 106, coupling the electrodes 192 with the HV source 188, and coupling the movable section 132 with the actuator 168. As noted above, in some embodiments, any liquids (including samples) and gels to be utilized may be dispensed into the wells 148 and/or troughs 152 and 156 prior to installing the capillary array device 100 in the sample analysis system. In such a case, no fluidic devices or circuits (whether or not provided by the sample analysis system) need to be coupled to the capillary array device 100.

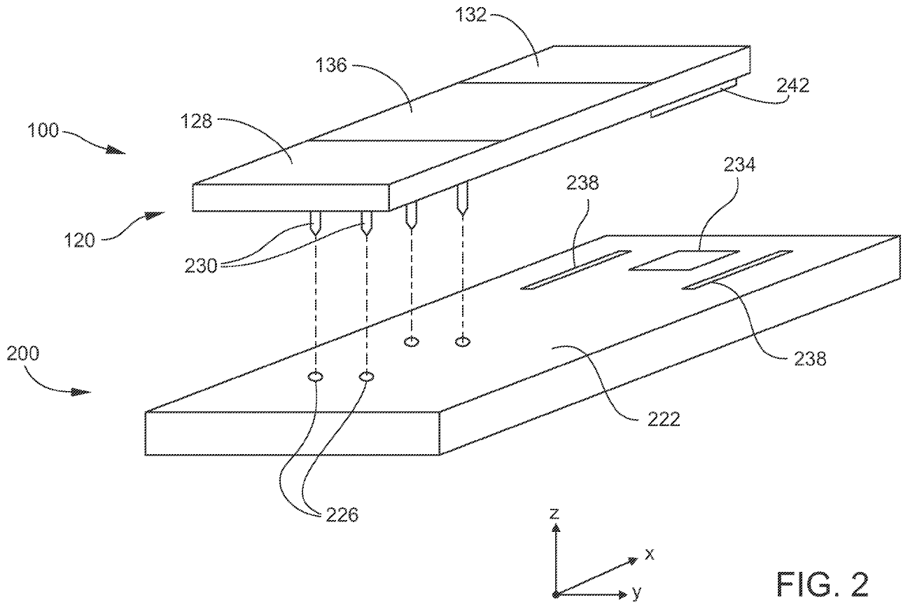

FIG. 2 is an exploded view of the capillary array device 100 and an example of a device support 200 configured to securely support the capillary array device 100 during its operation, according to an embodiment. For simplicity, the capillaries 124 are not shown. As one example, the capillary array device 100 first may be mounted to the device support 200 externally from a sample analysis system such as described herein, and then the assembly of the capillary array device 100 and the device support 200 may be installed in the sample analysis system. As another example, the device support 200 may be a fixed component of a receptacle of the sample analysis system that receives the capillary array device 100, in which case the capillary array device 100 may be mounted to the device support 200 during or after loading the capillary array device 100 into the receptacle. In the illustrated example, the body of the device support 200 includes a top surface 222 in which one or more alignment holes (or mounting holes) 226 are formed, which may be either blind holes or through-holes. The capillary array device 100 includes one or more alignment posts (or pins, etc.) 230 depending downwardly from the underside of the stationary section 128. The number and positional arrangement (pattern) of the alignment posts 230 matches those of the alignment holes 226. The capillary array device 100 is mounted to the device support 200 by aligning the alignment posts 230 with the alignment holes 226, and then lowering the capillary array device 100 onto the device support 200 such that the alignment posts 230 extend into the corresponding alignment holes 226. By this configuration, after the capillary array device 100 has been mounted to the device support 200 and is positioned in the receptacle of the sample analysis system, the detection area of the capillary array device 100 is properly optically aligned with the optics-based measurement device 106 (FIG. 1F) of the sample analysis system.

In another example, the capillary array device 100 may include the alignment holes 226 and the device support 200 may include the alignment posts 230. The alignment holes 226 and the alignment posts 230 may have any round or polygonal shapes. In another example, the alignment holes 226 and the alignment posts 230 may be elongated in at least one dimension (e.g., in the x-direction or y-direction). For example, the alignment holes 226 may be shaped as slots, and the alignment posts 230 may be shaped and plates or tabs.

In an example, the device support 200 may include an actuator opening 234 formed through its thickness (height) that is configured to accommodate one or more components of the actuator 168 (FIG. 1D) of the sample analysis system. In one example, the device support 200 and the actuator 168 may be attached together as an assembly.

In an example, the device support 200 may include one or more linear guide slots 238 formed in its top surface 232, and the capillary array device 100 may include one or more linear guide rails 242 depending downwardly from the underside of the movable section 132. The number and positional arrangement (pattern) of the linear guide rails 242 matches those of the linear guide slots 238. Accordingly, the linear guide rails 242 extend into the corresponding linear guide slots 238 when the capillary array device 100 is mounted to the device support 200. The engagement between the linear guide slots 238 and the linear guide rails 242 may assist in maintaining the linearity (straightness) of the movement of the movable section 132 along the device axis. Alternatively, the capillary array device 100 may include the linear guide slots 238 and the device support 200 may include the linear guide rails 242.

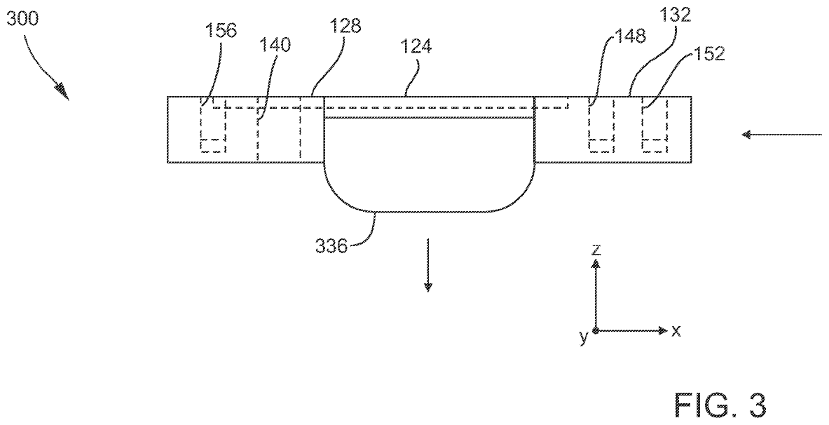

FIG. 3 is a longitudinal side elevation view of another example of a capillary array device 300 according to another embodiment of the present disclosure. FIG. 3 shows the capillary array device 300 in a flexed position, for example corresponding to the second or third positions shown in FIGS. 1B and 1C, respectively. The capillary array device 300 includes a flexible section 336 that is configured differently than the flexible section 136 of the capillary array device 100 described above in conjunction with FIGS. 1A-1C. As schematically depicted in FIG. 3, in response to axial movement of the movable section 132 (as indicated by a leftward-pointing arrow in FIG. 3) and consequent axial compression of the flexible section 336, the flexible section 336 is configured to flex and move predominantly in a downward direction (along the elevational axis, away from the overlying capillaries 124) as indicated by a downward-pointing arrow in FIG. 3. In one example and as noted above, the flexible section 336 may include one or more hinges (not shown) that facilitate this type of flexing (e.g., a hinge that pivots about the y-axis). The configuration of the capillary array device 200 may in many other respects be the same as or similar to that of the capillary array device 100 described above and illustrated in FIGS. 1A-1F.

FIGS. 4A-G illustrate an example of a capillary array device 400 according to another embodiment. FIGS. 4A and 4B are top perspective and top plan views of the capillary array device 400, respectively. The capillary array device 400 includes a flexible section 436 that has an open-frame configuration as generally described above. Specifically in the present example, the flexible section 436 is configured as an axially arranged series of diamond-shaped flexible segments 446. Depending on its relative position, each flexible segment 446 may be integrally adjoined to two adjacent flexible segments 446, or to an adjacent flexible segment 446 and the stationary section 128, or to an adjacent flexible segment 446 and the movable section 132. The flexible segments 446 are defined by a web of thin structural members (or compliant beams) 450 (as described above) that in turn define diamond-shaped openings 454 (FIG. 4B). The flexible segments 446, and consequently the flexible section 436 as a whole, act as a compliant spring that responds to movement of the movable section 132 in the manner described earlier in this disclosure. Movement of the movable section 132 axially compresses the flexible segments 446, whereby their diamond shapes “flatten,” and the flexible segments 446 may also move outwardly along the transverse axis.

In the present example, the capillary array device 400 also includes one or more structural braces 458 configured to stabilize the linear translation of the movable section 132 and/or contribute to the compliance and spring action of the flexible section 436. The braces 458 may or may not be considered to be part of the flexible section 436, depending on the example. For example, the braces 458 may be considered to be thin structural members of the flexible section 436. In the illustrated example, the capillary array device 400 includes at least two braces 458, one on each side of the flexible segments 446 relative to the transverse axis. Each brace 458 at one end is attached to or integral with the stationary section 128 and at the other end is attached to or integral with the movable section 132. In the illustrated example, the braces 458 are shaped as straps, which may have larger dimensions at their ends where they adjoin the stationary section 128 and the movable section 132, such as to improve the robustness of the configuration. The braces 458 may have a curved shape, as illustrated. In the present example, in response to movement of the movable section 132 toward the flexible section 436, the braces 458 move or bulge outward along the transverse axis.

The configuration of the capillary array device 400 may in many other respects be the same as or similar to that of the capillary array device 100 described above and illustrated in FIGS. 1A-1C. For example, the capillaries 124 may be fixed to and positioned on the capillary array holder of the capillary array device 400 in the same way as or similar way to the configuration of the capillary array device 100. Hence, the capillaries 124 may be fixed to the stationary section 128 such that the second capillary ends 164 are permanently disposed in the second trough 156, and the first capillary ends 160 may be selectively movable into the wells 148 and the first trough 152 in response to movement of the movable section 132. Moreover, the capillary array device 400 may be utilized in cooperation with components of a sample analysis system such as described above in conjunction with FIGS. 1D-1F.

In the present example, the top surface (or top surface sections between openings) of the capillary array holder (stationary section 128 and movable section 132) includes a plurality of grooves 462 in which the capillaries 124 are mounted. At least some of the grooves 462 of the stationary section 128 may serve as fixation sites 466 at which the capillaries 124 are fixed to the stationary section 128. As one non-exclusive example, a suitable glue may be applied at the fixation sites 466. The grooves 462 of the movable section 132 may assist in guiding the linear movement of the movable section 132 relative to the capillaries 124.

FIG. 4C is a cut-away, perspective top view of the capillary array device 400 taken along line A-A shown in FIG. 4B, which is coincident with one of the capillaries 124 and associated grooves 462. FIG. 4D is a cut-away, longitudinal side elevation view taken along same line A-A shown in FIG. 4B, thus showing the same capillary 124 and associated grooves 462. In the present example, some of the sections of the grooves 462, such as at the entrances into the wells 148 and the first trough 152, may include tapered or conical portions 470 to assist in guiding the capillaries 124 during movement of the movable section 132 as the capillaries 124 enter open spaces such as the wells 148 and the first trough 152.

FIGS. 4E-4G are top plan views of the capillary array device 400, shown in a first position, second position, and third position, respectively. For simplicity, the flexible section 436 is not shown in FIGS. 4E-4G. In the present example, the capillary array device 400 operates in the first, second, and third positions in the same way as the capillary array device 100 described above in conjunction with the first, second, and third positions shown in FIGS. 1A-1C.

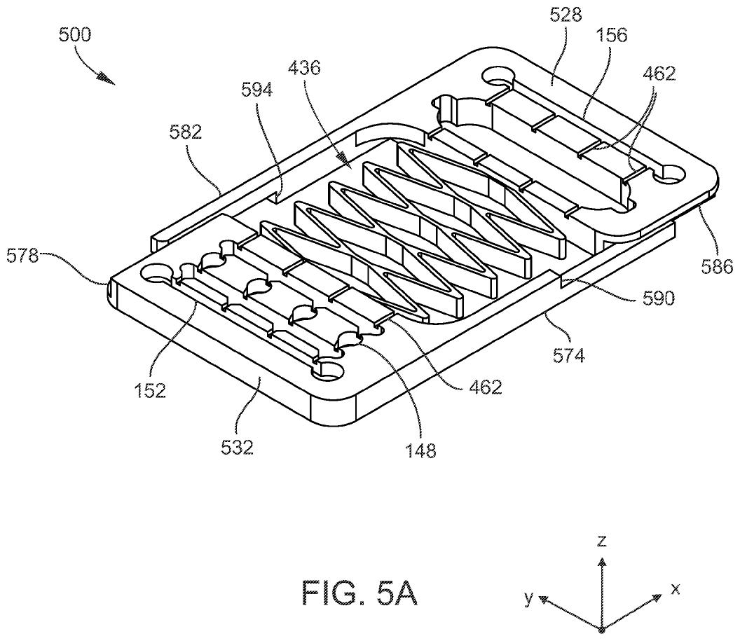

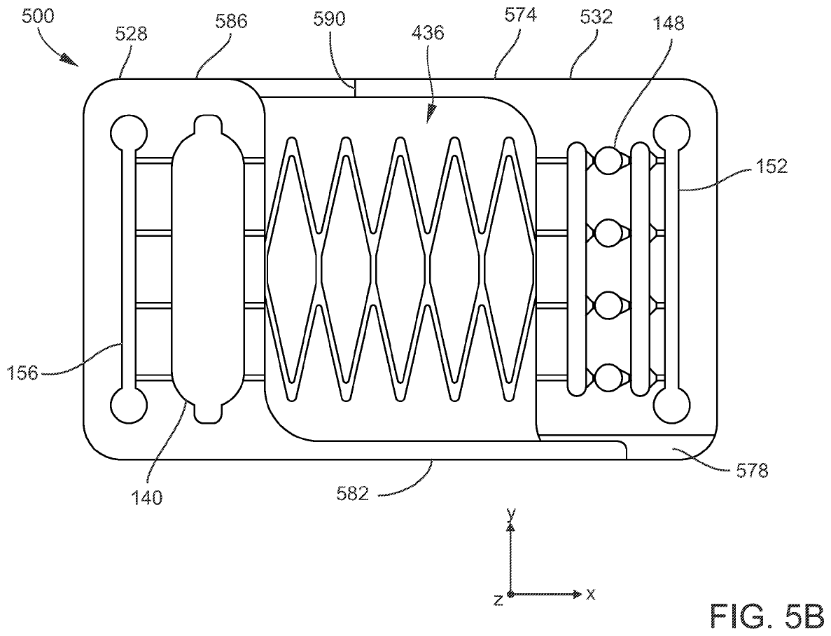

FIGS. 5A and 5B illustrate an example of a capillary array device 500 according to another embodiment. Specifically, FIG. 5A is a top perspective view of the capillary array device 500, and FIG. 5B is a top plan view of the capillary array device 500. The capillaries 124 are not shown in FIGS. 5A and 5B. In this example, the capillary array device 500 includes guide features configured to guide the axial movement of the capillary array device 500 to the various operating positions described herein. Such guide features may be integrated with a stationary section 528 and a movable section 532 of the capillary array device 500. Specifically as illustrated, the movable section 532 includes a first axial leg 574 and a first axial recess (or channel, or other axially elongated space) 578, both extending along the device axis but on opposite sides of the movable section 532 relative to the transverse axis. The stationary section 528 includes a second axial leg 582 and a second axial recess (or channel, or other axially elongated space) 586, both extending along the device axis but on opposite sides of the stationary section 528 relative to the transverse axis. In operation, as the movable section 532 axially moves toward the flexible section 436, the first axial leg 574 axially moves through or adjacently to the second axial recess 586, and the first axial recess 578 axially moves around or adjacently to the second axial leg 582 (or, in effect, the second axial leg 582 axially moves through or adjacently to the first axial recess 578). By this configuration, these guide features (first axial leg 574, first axial recess 578, second axial leg 582, and second axial recess 586) assist in maintaining the linearity or straightness of the axial movement of the movable section 532 relative to the capillaries 124 and stationary section 528, such as by limiting transverse movement (along the transverse axis) of the movable section 532. For this purpose, the first axial leg 574 and the second axial leg 582 may or may not contact surfaces of the second axial recess 586 and the first axial recess 578, respectively, during the movement of the movable section 532.

Also in the present example, the first axial leg 574 may include a first shoulder 590 and the second axial leg 582 may include a second shoulder 594. The first shoulder 590 and the second shoulder 594 may serve as mechanical stops that limit the axial extent of the movement of the movable section 532. In other words, if the movable section 532 were to move far enough in the direction of the flexible section 436, the first shoulder 590 would contact a surface of the stationary section 528 and/or the second shoulder 594 would contact a surface of the movable section 532, thereby preventing further axial movement.

In the illustrated example, the flexible section 436 of the capillary array device 500 is the same as or similar to the flexible section 436 of the capillary array device 400 described above and illustrated in FIGS. 4A and 4B. However, the flexible section 436 of the capillary array device 500 may have any of the flexible configurations described and/or illustrated herein.

The configuration of the capillary array device 500 may in many other respects be the same as or similar to that of the capillary array device 100 described above and illustrated in FIGS. 1A-1C, and/or the capillary array device 400 described above and illustrated in FIGS. 4A and 4B. For example, the capillary array device 500 may be capable of axially moving among first, second, and third positions as described above and illustrated in FIGS. 1A-1C or FIGS. 4E-4G. Moreover, the capillary array device 500 may be utilized in cooperation with components of a sample analysis system such as described above in conjunction with FIGS. 1D-1F.

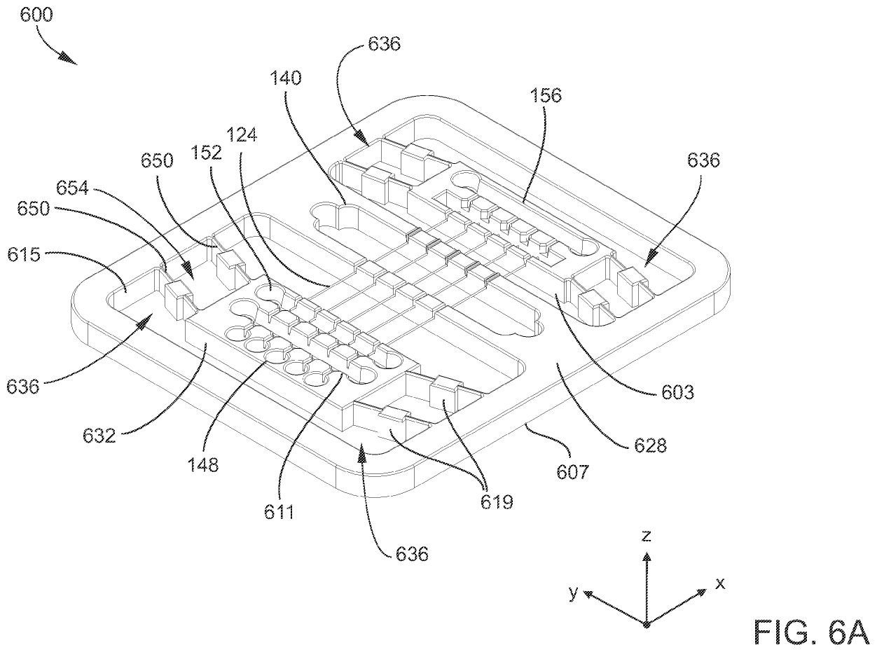

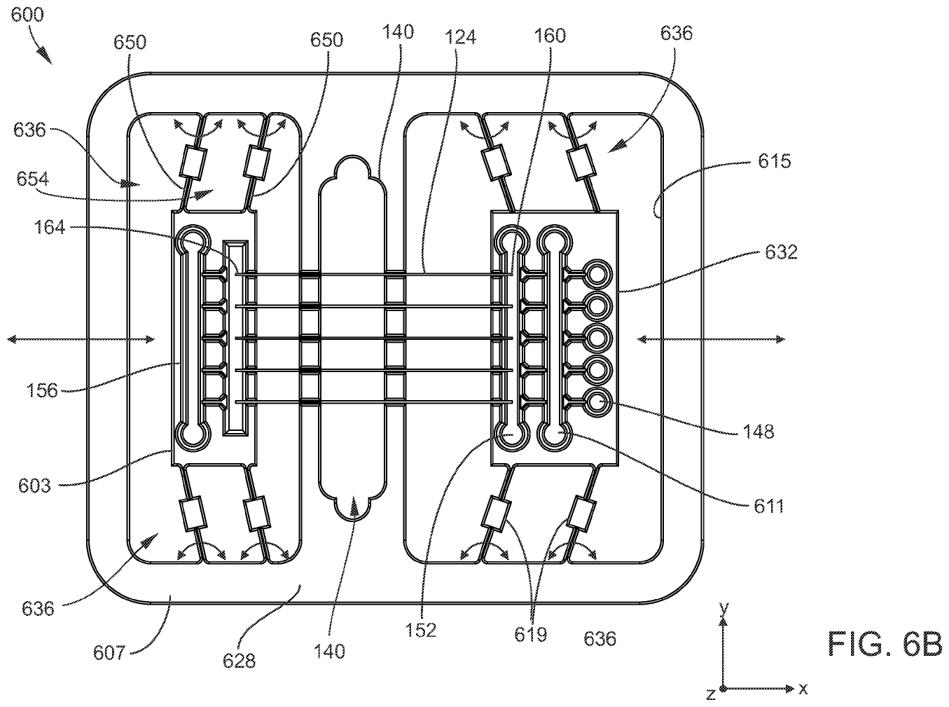

FIGS. 6A and 6B illustrate an example of a capillary array device 600 according to another embodiment. Specifically, FIG. 6A is a top perspective view of the capillary array device 600, and FIG. 6B is a top plan view of the capillary array device 600. In this example, the capillary array device 600 includes more than one movable section, namely, a first movable section 632 and a second movable section 603. The capillary array device 600 also includes more than one stationary section, namely, a first stationary section 628 and a second stationary section 607 (or, equivalently, the stationary section of the capillary array device 600 includes a first stationary portion 628 and a second stationary portion 607). In the device plane, the first stationary section 628 is positioned axially between the first movable section 632 and the second movable section 603, and the second stationary section 607 surrounds the first movable section 632 and the second movable section 603. In the present example, the first stationary section 628 and the second stationary section 607 are integrally adjoined, i.e., they have a single-piece configuration. In other examples, however, the first stationary section 628 and the second stationary section 607 may be separate components.

In the present example, the detection area 140 is located at the first stationary section 628. The wells 148 and the first trough 152 are located at the first movable section 632, and the second trough 156 is located at the second movable section 603. In addition, the capillary array device 600 includes a third trough 611, which is located at the first movable section 632 but alternatively may be located at the second movable section 603, depending on the embodiment. The third trough 611 may serve as an additional source of a liquid or gel. As in other embodiments, additional troughs may be provided is needed for a particular application. In the present example, the first trough 152 is axially positioned closer to the capillaries 124 than the third trough 611 and the wells 148, the wells 148 are axially positioned farther from the capillaries 124 than the first trough 152 and the third trough 611, and the third trough 611 is thus axially positioned between the first trough 152 and the capillaries 124.

In the present example, the capillary array device 600 includes a flexible section 636 that includes a plurality of thin structural members (or compliant beams) 650 separated by openings 654 that pass through the thickness (height) of the flexible section 636. For example, and as illustrated, one or more structural members 650 interconnect (i.e., are integrally adjoined or attached to) the second stationary section 607 and one side of the first movable section 632, and one or more additional structural members 650 interconnect the second stationary section 607 and the opposing side of the first movable section 632 (“opposing” being relative to the transverse axis). Similarly, one or more additional structural members 650 interconnect the second stationary section 607 and one side of the second movable section 603, and one or more additional structural members 650 interconnect the second stationary section 607 and the opposing side of the second movable section 603. Stated differently, each structural member 650 is tethered to the second stationary section 607 and also to either the first movable section 632 or the second movable section 603. In the present example, the structural members 650 are adjoined or attached to inside walls 615 of the second stationary section 607 (e.g., walls 615 facing the central device axis) and to outer walls of the first movable section 632 or second movable section 603. As further illustrated, each of the structural members 650 may include one or more “thick” sections or boxes 619, which may be solid or partially hollow. Each box 619 is larger, or “thicker,” than the rest of (the “thin” sections of) the corresponding structural member 650, where the terms “thick” and “thin” are relative to each other. The boxes 619 may be useful for controlling the compliance of the structural members 650. For example, larger (e.g., longer) boxes 619 may decrease the compliance. Accordingly, the compliance of the structural members 650 may be controlled (or adjusted or tuned) by selecting the size of the box 619 (and/or number of boxes 619) provided with each structural member 650. The boxes 619 may also be useful for providing enhanced structural support for the structural members 650.

In the present example, the flexible section 636 is configured such that, in response to axial movement of the first movable section 632 or the second movable section 603 as indicated by double-headed straight arrows in FIG. 6B, the corresponding structural members 650 will pivot (or swing) in the device plane as indicated by double-headed curved arrows in FIG. 6B. The pivot points are located at the interfaces between the second stationary section 607 and the first movable section 632 and second movable section 603.

In the present example, the capillary array device 600 is axially movable among at least three (first, second, and third) positions. FIGS. 6A and 6B show the capillary array device 600 in the first (or initial, or storage) position. At the first position, the first movable section 632 and the second movable section 603 have not been moved (e.g., actuated), and thus the flexible section 636 is relaxed (is not flexed). At the first position, the first capillary ends 160 are positioned inside the first trough 152. Accordingly, upon dispensing a liquid or gel into the first trough 152, the liquid or gel will be passively loaded into the capillaries 124 via the first capillary ends 160 by capillary action. The capillary array device 600 may then be moved to the second position by axially moving the first movable section 632 toward the first stationary section 628 (axially translating the first movable section 632 to the left in FIG. 6B). At the second position, the first capillary ends 160 now are positioned inside the third trough 611, which may be filled, before or after moving to the second position, with a liquid or gel that may be different from the liquid or gel provided in the first trough 152. The capillary array device 600 may then be moved to the third position by axially moving the first movable section 632 further toward the first stationary section 628 (axially translating the first movable section 632 further to the left in FIG. 6B), and also by axially moving the second movable section 603 toward the first stationary section 628 (axially translating the second movable section 603 to the right in FIG. 6B). At the third position, the first capillary ends 160 now are positioned inside the wells 148, which may be filled, before or after moving to the third position, with a liquid or gel that may be different from the liquids or gels provided in the first trough 152 and third trough 611. In addition, the second capillary ends 164 are now positioned inside the second trough 156, which may be filled, before or after moving to the third position, with a liquid or gel that may be different from the liquids or gels provided in the wells 148, first trough 152, and third trough 611.

In another example, the third position may be split into a third position and a separate fourth position. At the third position, the first capillary ends 160 are positioned inside the wells 148. At the subsequent fourth position, the second capillary ends 164 are positioned inside the second trough 156. Alternatively, the second capillary ends 164 may be positioned inside the second trough 156 at the third position and, subsequently, the first capillary ends 160 may be positioned inside the wells 148.

The specific use, sequence of movements, and number of different positions of the capillary array device 600 depend on the specific application for which the capillary array device 600 is being utilized. Hence, the sequence of movements may be different from that just described. For example, at the first position, the first capillary ends 160 may be initially positioned in any of the containers of the first movable section 632 (e.g., the wells 148, first trough 152, and third trough 611), or the first capillary ends 160 may not be initially positioned in any of these containers. At other positions reached subsequently to the first position (e.g., second, third, fourth, et seq.), the first capillary ends 160 may or may not be positioned in any of the containers of the first movable section 632, and the second capillary ends 164 may or may not be positioned in any of the containers of the second movable section 603 (e.g., the second trough 156).

As in other embodiments, electrodes (such as the electrodes 192 described above in conjunction with FIG. 1E) may be included in any of the wells 148, first trough 152, second trough 156, and third trough 611 to implement loading of a liquid or gel into the capillaries 124 and/or transport of a liquid or gel through the capillaries 124 by electrokinetics.

In the present example, the flexible section 636 is configured as a compliant spring that biases the first movable section 632 and the second movable section 603 toward the first position shown in FIGS. 6A and 6B. That is, the relaxed state of the flexible section 636 corresponds to the first position. In the present example, as best seen in FIG. 6B, in the relaxed state, the structural members 650 of the flexible section 636 are oriented at an angle relative to the transverse axis (and the device axis). As the first movable section 632 moves (left) toward the first stationary section 628, or as the second movable section 603 toward the moves (right) toward the first stationary section 628, the structural members 650 will pivot in the relevant direction and start to flex. By this pivoting, the structural members 650 may start to “straighten out,” i.e., the angles between the structural members 650 and the transverse axis may become reduced. This type of flexing may involve some degree of compression and/or stretching and/or bending of the structural members 650, depending on the embodiment. By this configuration, upon removing the actuating force being applied to the first movable section 632 or the second movable section 603, the first movable section 632 or the second movable section 603 will move back to the relaxed state (first position) shown in FIGS. 6A and 6B due to the biasing forces imparted by the structural members 650.

In an example, an actuator, such as the actuator 168 described above and illustrated in FIG. 1D, may be configured to selectively and independently actuate the movements of the first movable section 632 and the second movable section 603. Alternatively, two such actuators 168 may be provided, in which case a first actuator is coupled to or contacts the first movable section 632 and a second actuator is coupled to or contacts the second movable section 603.

The T configuration of the capillary array device 600 may in many other respects be the same as or similar to that of the capillary array device 100 described above and illustrated in FIGS. 1A-1C, and/or the capillary array device 400 described above and illustrated in FIGS. 4A and 4B, and/or the capillary array device 500 described above and illustrated in FIGS. 5A and 5B. Moreover, the capillary array device 600 may be utilized in cooperation with components of a sample analysis system such as described above in conjunction with FIGS. 1D-1F.

As in other embodiments, the capillary array device 600 may be configured for CE as described herein. In one example, the wells 148 are utilized as sample wells, the first trough 152 is utilized as a (first) gel trough configured to contain a (first) CE separation medium, the second trough 156 is utilized as a buffer trough, and the third trough 611 is utilized as a (second) gel trough configured to contain an (second) CE separation medium having a different composition than the first CE separation medium contained in the first trough 152.

A method for analyzing a sample by CE that utilizes the capillary array device 600 will now be described. According to the method, the capillary array device 600 is initially provided in the first position shown in FIG. 6A, at which the first capillary ends 160 are inside the first trough 152 (first gel trough). The first trough 152 is filled with a desired amount of the first CE separation medium, and the third trough 611 (second gel trough) is filled with a desired amount of the second CE separation medium. The capillary array device 600 is held at the first position for a predetermined period of time sufficient to partially fill the capillaries 124 with the first CE separation medium. In other words, at the first position, a plug of the first CE separation medium is formed in each capillary 124. After the period of time allotted for loading the first CE separation medium has elapsed, the capillary array device 600 is moved to the second position, at which the first capillary ends 160 are inside the third trough 611. The capillary array device 600 is held at the second position for a predetermined period of time sufficient to partially fill the capillaries 124 with the second CE separation medium, thereby forming plugs of the second CE separation medium in the respective capillaries 124. According to this method, an axial position-dependent, composite CE separation matrix is formed in each capillary 124, with each CE separation matrix including an axially “stacked” arrangement of plugs of different CE separation media. The use of multiple, different CE separation media in the same capillary 124 may provide advantages in the separation and analysis of certain types of samples. Depending on the time durations for which the capillary array device 600 is held at the first and second positions, in each capillary 124, the plug of first CE separation medium and the plug of second CE separation medium may be directly adjacent to each other. Alternatively, the plug of first CE separation medium and the plug of second CE separation medium may be spatially separated from each other, and the intervening space may be occupied by buffer solution and/or sample solution.

After the period of time allotted for loading the second CE separation medium has elapsed, the capillary array device 600 is moved to the third position, at which the first capillary ends 160 are positioned inside the wells 148 (sample wells) and the second capillary ends 164 are positioned inside the second trough 156 (buffer trough). Before or after moving to the third position, the wells 148 are filled with samples and the second trough 156 is filled with a buffer solution. At the third position, an electrical circuit is formed between an HV source (e.g., the HV source 188 shown in FIG. 1E) and electrodes positioned in the wells 148 and the second trough 156 (e.g., electrodes 192 shown in FIG. 1E). A voltage pulse is then applied across the lengths of the capillaries 124 to electrokinetically inject the samples as sample plugs into the front regions of the capillaries 124 (the first capillary ends 160). Next, another voltage is applied according to predetermined operating parameters effective for inducing electrophoretic separation of different analytes of the samples in each capillary 124, as described elsewhere herein. The separated analytes in each capillary 124 may then be detected/measured at the detection area 140 by an optics-based measurement device (e.g., the optics-based measurement device 106 shown in FIG. 1F). Subsequently, as in other embodiments, after acquiring the CE data from the samples, the capillary array device 600 may be discarded if desired.

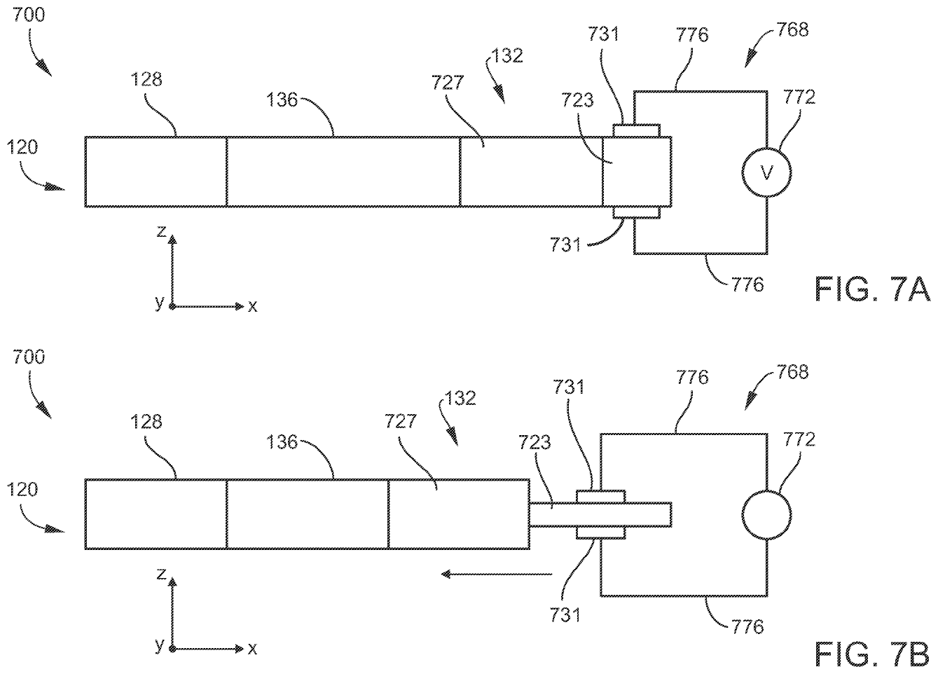

FIGS. 7A and 7B illustrate an example of a capillary array device 700 that includes an intrinsic actuator 723. In this example, the intrinsic actuator 723 is a DEA, but alternatively may be configured according to any of the other examples of intrinsic actuators described herein. FIG. 7A is a longitudinal side elevation view of the capillary array device 700 while in a non-actuated position, which may correspond to a first position as described herein. FIG. 7B is a longitudinal side elevation view of the capillary array device 700 while in an actuated position, which may correspond to a second, third, fourth, etc., position as described herein. For simplicity, FIGS. 7A and 7B do not show the capillaries 124 and certain other features that may be included and described herein, such as containers (wells, troughs, etc.).

In the present example, the movable section 132 is considered to include the intrinsic actuator 723 as well as a non-intrinsically actuatable component 727 that is coupled to or in contact with (or contactable with) the intrinsic actuator 723. The non-intrinsically actuatable component 727 may be, for example, a body of material corresponding to the movable section 132 described above in conjunction with FIGS. 1A-1F, which may include one or more of the containers described herein. Also in the present example, the capillary array device 700 an actuator (assembly) 768 that is configured to actuate (or stimulate, activate, etc.) the intrinsic actuator 723. In the present example, the actuator 768 includes an actuating device 772 in the form of a voltage source, two or more electrodes 731 contacting the upper and lower planar sides of the intrinsic actuator 723, and an electrical (wired) link 776 in the form of appropriate electrical interconnects (e.g., wires) coupling the actuating device 772 and the electrodes 731 so as to form a closed electrical circuit. The electrodes 731 are arranged in parallel and positioned such that the intrinsic actuator 723 is sandwiched between one or more electrodes 731 at the upper side and one or more electrodes 731 at the lower side.

The actuation of the capillary array device 700 is illustrated by the transition from FIG. 7A to FIG. 7B. In this example, the electrodes 731 are oriented in the transverse (x-y) plane. Thus, the application of a voltage by the actuating device 772 between the electrodes 731 (and thus across the thickness of the intrinsic actuator 723) will squeeze the intrinsic actuator 723 in the thickness direction, thereby expanding the intrinsic actuator 723 in the transverse plane (in both the x-direction and y-direction). The intrinsic actuator 723 and other components of the capillary array device 700 are mounted such that this actuation causes the intrinsic actuator 723 to move the non-intrinsically actuatable component 727 relative to the capillaries, which in the present example is in a direction toward the flexible section 136 (to the left in FIGS. 7A and 7B) as indicated by a leftward-pointing arrow in FIG. 7B. This movement in turn causes the flexible section 136 to flex in accordance with any of the examples described herein.

Alternatively, the capillary array device 700 may be configured according to any of the other embodiments disclosed herein that include an intrinsic actuator. Thus, the intrinsic actuator 723 may be oriented and/or positioned differently, the intrinsic actuator 723 may be a different type (e.g., SMP, SMA, etc.), the actuating device 772 may be a different type (e.g., heat source, light source, magnetic source, etc.), etc.

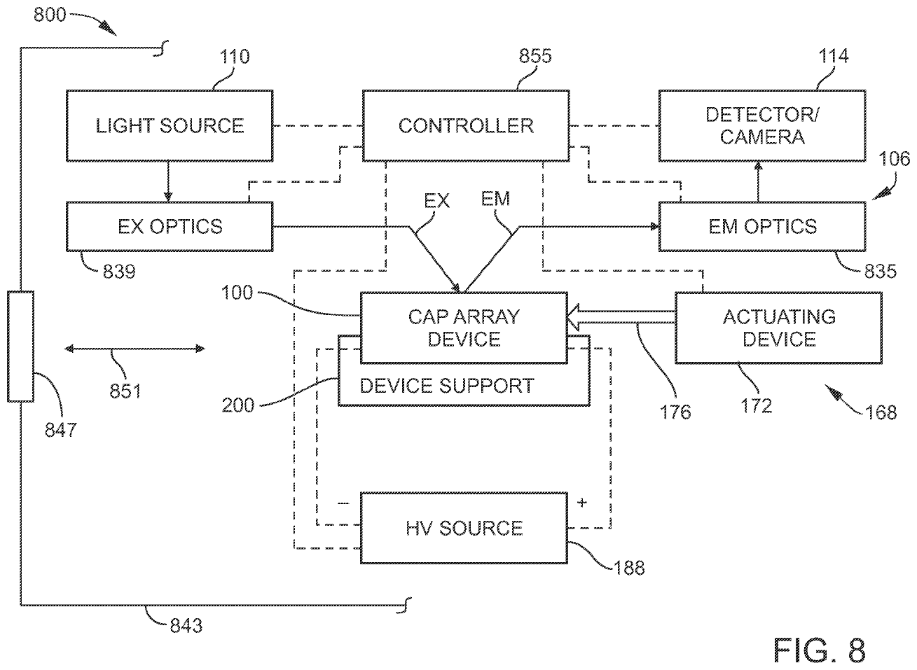

FIG. 8 is a schematic view of an example of a sample analysis system (or apparatus, analytical instrument, etc.) 800 according to an embodiment of the present disclosure. The sample analysis system 800 includes one or more capillary array devices as disclosed herein, such as the capillary array device 100, 300, 40, 500, or 600. The sample analysis system 800 is configured for performing optical measurements on a samples in the capillaries 124 (not shown in FIG. 8) such as, for example, chemical compounds, biological compounds, biological cells or component(s) thereof, etc. In the context of the present disclosure, the term “optical measurements” encompasses imaging (e.g., microscopic imaging) as well as measurements of more specific properties or attributes (e.g., presence or absence of an analyte, concentration, mass, charge, number, size, etc.), depending on the type of sample analysis system 800. In various examples, the optical measurements may be based on fluorescence, absorbance, luminescence (including chemiluminescence or bioluminescence), (UV, Visible, or IR) spectroscopy, Raman scattering, microscopy, etc. Generally, the structure and operation of the various components provided in optical-based sample analysis instruments are understood by persons skilled in the art, and thus are only briefly described herein to facilitate an understanding of the presently disclosed subject matter.

The sample analysis system 800 may include an optical system 106 as described herein. The capillary array device 100 is configured to be loaded into an operative position in the sample analysis system 800, such that the capillaries 124 (or windows thereof) supported by the capillary array device 100 are in proper optical alignment with the optical system 106. The optical system 106 includes one or more light detectors (or cameras) 114 configured to receive and measure emission light EM emitted from the exposed (optically readable) section of the capillary array device 100. Examples of a light detector 114 include, but are not limited to, a camera, a photomultiplier tube (PMT), a photodiode (PD), a charge-coupled device (CCD), an active-pixel sensor (APS) such as a complementary metal-oxide-semiconductor (CMOS) device, etc., which are sensitive to the emission wavelengths to be detected.

In some examples (depending on the type of sample analysis system 800), the optical system 106 further includes one or more light sources 110 configured to irradiate samples in the capillaries 124 in the exposed section of the capillary array device 100, by directing excitation light EX at a selected wavelength or wavelengths. Examples of a light source 110 include, but are not limited to, a broadband light source (e.g., flash lamp), a light emitting diode (LED), a laser diode (LD), a laser, etc. Multiple light sources 110 may be provided to enable a user to select a desired excitation wavelength.

The optical system 106 may further include various types of emission optics 835 configured to transmit the emission light EM from the capillary array device 100 to the light detector 114, or additionally excitation optics 839 configured to transmit the excitation light EX from the light source 110 to the capillary array device 100. Examples of emission optics 835 or excitation optics 835 include, but are not limited to (and as needed, and as appreciated by persons skilled in the art), lenses, read heads, apertures, optical filters (including, e.g., multiple, selectable filters), light guides, mirrors, beam splitters, beam steering devices, monochromators, diffraction gratings, prisms, optical path switches, etc.

The sample analysis system 800 may include an instrument console (or apparatus housing, enclosure, etc.) 843 that is configured to contain the capillary array device 100, the optical system 106, and other components of the sample analysis system 800 including those associated with the capillary array device 100 such as shown in FIGS. 1D-1F, 2, and 7A-7F. The instrument console 843 is also configured to prevent stray light from reaching the capillaries 124 and components of the optical system 106 that may be adversely affected by stray light. The instrument console 843 also provides an enclosed environment for enabling environmental control (e.g., control of temperature, humidity, pressure, etc.) of the console interior if needed. The instrument console 843 may include one or more panels, doors, drawers, etc., for loading/removing the capillary array device 100 and other portable/replaceable components, for providing access to interior regions and components of the sample analysis system 800, etc. As an example, FIG. 8 illustrates a door 847 that may be opened to enable the capillary array device 100 (with or without the device support 200) to be loaded into and thereafter removed from the console interior, as indicated by a double-headed arrow 851 in FIG. 8. The loading/removing of the capillary array device 100 may be done manually or (semi) automatically. As described herein, the samples and various liquids and/or gels may be preloaded in the capillaries 124 prior to installing the capillary array device 100 into the sample analysis system 800 and carrying out analyses.

The sample analysis system 800 also may include an actuator 168 (or 768), including an actuating device 172 (or 772) and a (contacting or non-contacting) link 176 (or 776) according to any of the embodiments described herein. The sample analysis system 800 also may include an HV source 188 configured to apply a voltage (potential difference) across the capillaries 124 as described herein.

The sample analysis system 800 further may include a system controller 855.

The system controller 855 generally represents one or more electronics-based (e.g., computing) devices or modules that include various types of hardware (e.g., electronics-based processors, memories, non-transitory computer-readable media, etc.), firmware (e.g., integrated circuits or ICs), and/or software configured to perform various functions needed for operating the type of sample analysis system 800 provided. The system controller 855 may be embodied as one or more types of hardware such as circuit boards. The system controller 855 may include data acquisition circuitry (DAC) configured to receive and process signals outputted from the light detector 114, and produce user-interpretable data therefrom that represent the results of the sample analysis. The system controller 855 may also be taken as representing devices configured to control, monitor, and synchronize the operation of various components of the sample analysis system 800, such as the light detector 114, emission optics 835 (e.g., if including a component consuming power or capable of automated adjustment), light source 110, excitation optics 839 (e.g., if including a component consuming power or capable of automated adjustment), actuator 168, and HV source 188). The system controller 855 may also be taken as representing user input and output devices such as keyboards, display monitors, printers, graphical user interfaces (GUIs), etc. The system controller 855 may include an operating system (e.g., Microsoft Windows® software) for controlling and managing various functions of the system controller 855. In an example, the system controller 855 is configured to control or perform all or part of any of the methods disclosed herein. For all such purposes, the system controller 855 may communicate with the above-noted components via wired or wireless communication links that enable the transmission of signals (e.g., the sending of control signals, the receiving of measurement or feedback signals, etc.).

An example of a general method for analyzing samples, in particular entailing the use of the capillary array device 100, will now be described. The capillary array device 100 containing the samples is provided. In the present example, providing the capillary array device 100 includes injecting the samples and one or more liquids and/or gels into the capillaries 124 in accordance with any of the methods disclosed herein. Providing the capillary array device 100 also may include loading the capillary array device 100 into an operating position in the sample analysis system 800 to place the capillary array device 100 in proper optical alignment with the optical system 106 of the sample analysis system 800. Depending on the type of sample analysis being performed, the samples may be subjected to various types of preparation or conditioning (incubation, mixing, homogenization, centrifuging, buffering, reagent addition, denaturing, lysing, cleaving, de-protecting, etc.) prior to being positioned in the sample analysis system 800, as appreciated by persons skilled in the art.

After providing capillary array device 100 as just described, the method includes making an optical measurement of the samples in the capillaries 124 to acquire optical data from one or more analytes of the samples. In a typical example, making an optical measurement entails irradiating the samples with excitation light EX, and collecting the resulting emission light EM emitted from the samples in response to the irradiation. In the present example, the optical system 106 of the sample analysis system 800 described above is operated to make the optical measurement. In some examples, the excitation light EX induces a photoluminescent (e.g., fluorescent or phosphorescent) response in one or more analytes of the samples, and the optical measurement relates to measuring the intensity of the photoluminescent light to quantify (e.g., determine the concentration of) the analyte(s), or additionally to produce images of the samples that include the photoluminescing analyte(s). In other examples, the excitation light EX is utilized to illuminate the samples without necessarily inducing photoluminescence, and the emission light EM is utilized to measure absorbance of the samples to quantify the analyte(s), or additionally to produce images of the samples.

In other examples, making an optical measurement does not require irradiating the samples with excitation light EX. For example, a reagent may be added to the sample that induces luminescence, such as flash luminescence or glow luminescence, as appreciated by persons skilled in the art. As another example, labels may be added to the samples, such as stable labels or radiolabels, depending on the type of optical measurement being made.

In all such cases, the emission optics 835 of the optical system 106 of the sample analysis system 800 may be operated to collect the emission light EM from the sample and direct the emission light EM to the light detector 114. The emission light EM may be detected either on the same side of the capillary array device 100 at which the excitation light EX is incident (e.g., the top side), or on the opposite side (e.g., excitation is done on the top side while detection is done on the bottom side). The light detector 114 then converts the emission light EM into electrical signals (detection or measurement signals) and transmits the electrical signals to signal processing circuitry, such as the data acquisition circuitry of the system controller 855, described above.

In one example, the sample analysis system 800 is configured as a capillary electrophoresis (CE) system. In this case, the capillaries 124 contain an electrophoretic separation medium (i.e., an analytical separation medium formulated for CE). In the present example, the electrophoretic separation medium is an electrophoretic polymer gel, which may be a polymer formulated for CE such as described herein. For performing CE, the HV source 188 of the sample analysis system 800 is operated to apply a potential difference across the lengths of each of the capillaries 124, as described herein. The HV source 188 represents the various components needed for applying a potential difference having desired operating parameters (amplitude/magnitude, frequency, waveform(s), pulse rate, etc.) for implementing CE, such as a waveform generator, amplifier, etc., as appreciated by persons skilled in the art.

Another example of a method for analyzing samples, specifically in the context of CE, will now be described. The method may generally include the steps of providing the capillary array device 100 and subsequently making an optical measurement of the samples in the capillaries 124 to acquire optical data from one or more analytes of the samples. In the present example, the method further includes, before and/or during making the optical measurement, applying a potential difference across the capillaries 124 (typically simultaneously, in parallel, but may be done sequentially). The potential difference induces different analytes to migrate through the electrophoretic separation medium at different speeds dependent on their differing sizes and/or electrical charge state, according to mechanisms generally understood by persons skilled in the art. In this way, the different analytes become separated from each other, thereby facilitating the optical measurement of one or more target analytes of interest in the samples.

In another example, another type of analytical separation medium may be utilized in the capillaries 124 such as, for example, a chromatographic separation medium.

### EXEMPLARY EMBODIMENTS

Exemplary embodiments provided in accordance with the presently disclosed subject matter include, but are not limited to, the following:

1. A capillary array device, comprising: a capillary array holder comprising a stationary section, a movable section, and a flexible section coupling the stationary section and the movable section; and a plurality of capillaries attached to the capillary array holder, wherein the capillaries are arranged in parallel and elongated along a device axis of the capillary array holder, and wherein: the movable section is linearly movable along the device axis relative to the capillaries and the stationary section; and the flexible section flexes in response to movement of the movable section.
2. The capillary array device of embodiment 1, comprising a detection area configured to allow transmission of light into and out from the detection area.
3. The capillary array device of embodiment 2, wherein the stationary section comprises the detection area.
4. The capillary array device of embodiment 2, wherein the movable section comprises the detection area.
5. The capillary array device of any of the preceding embodiments, wherein the capillary array holder has an overall length along the device axis, and the stationary section, the movable section, and the flexible section are arranged such that the movement of the movable section changes the overall length.
6. The capillary array device of any of the preceding embodiments, wherein the capillary array holder comprises a plurality of wells configured to contain respective liquids or gels, and the wells are positioned such that each capillary is aligned with a respective one of the wells along the device axis, and wherein the capillaries are movable into and out from the respective wells in response to movement of the movable section.
7. The capillary array device of embodiment 6, wherein the movable section comprises the wells.
8. The capillary array device of embodiment 6, wherein the stationary section comprises the wells.
9. The capillary array device of any of embodiments 6-8, wherein: the capillaries comprise respective first capillary ends and second capillary ends opposing the first capillary ends along the device axis; and the movable section is configured to move from a first position at which the first capillary ends are outside the wells, to a second position at which the first capillary ends are inside the wells.
10. The capillary array device of any of embodiments 6-9, wherein the capillary array holder comprises a plurality of electrodes, and each electrode is positioned in a respective one of the wells.
11. The capillary array device of any of the preceding embodiments, wherein: the capillaries are arranged side-by-side along a transverse axis orthogonal to the device axis; and the capillary array holder comprises a trough extending along the transverse axis and configured to contain a liquid or a gel, and the trough is wide enough along the transverse axis to receive all of the capillaries simultaneously.
12. The capillary array device of embodiment 11, wherein the movable section comprises the trough.
13. The capillary array device of embodiment 11, wherein the stationary section comprises the trough.
14. The capillary array device of any of embodiments 11-13, wherein the capillary array holder comprises an electrode is positioned in the trough.
15. The capillary array device of any of the preceding embodiments, wherein: the capillaries are arranged side-by-side along a transverse axis orthogonal to the device axis; the capillaries comprise respective first capillary ends and second capillary ends opposing the first capillary ends along the device axis; the capillary array holder comprises a plurality of wells configured to contain respective liquids or gels, and the wells are positioned such that each first capillary end is aligned with a respective one of the wells along the device axis, and wherein the first capillary ends are movable into and out from the respective wells in response to movement of the movable section; and the capillary array holder comprises a trough extending along the transverse axis, and capillary array holder has a configuration according to one of: the second capillary ends are disposed in the trough in a fixed manner; the first capillary ends are movable into and out from the trough in response to movement of the movable section.
16. The capillary array device of embodiment 15, wherein the capillary array holder comprises a plurality of electrodes, at least one electrode is positioned in each of the wells, and at least one other electrode is positioned in the trough.
17. The capillary array device of any of embodiments 15-16, wherein the movable section comprises the wells, and the stationary section comprises the trough.
18. The capillary array device of any of the preceding embodiments, wherein: the capillaries are arranged side-by-side along a transverse axis orthogonal to the device axis; the capillaries comprise respective first capillary ends and second capillary ends opposing the first capillary ends along the device axis; the capillary array holder comprises a plurality of wells configured to contain respective liquids or gels, and the wells are positioned such that each first capillary end is aligned with a respective one of the wells along the device axis, and wherein the first capillary ends are movable into and out from the respective wells in response to movement of the movable section; the capillary array holder comprises a first trough, and the first trough is positioned along the transverse axis in alignment with the first capillary ends, and wherein the first capillary ends are movable into and out from the first trough in response to movement of the movable section; the capillary array holder comprises a second trough extending along the transverse axis and configured to receive the second capillary ends.
19. The capillary array device of embodiment 18, wherein the movable section comprises the wells and the first trough, and the stationary section comprises the second trough.
20. The capillary array device of any of embodiments 18-19, wherein: the movable section is configured to move among a first position, a second position, and a third position; at the first position, the first capillary ends are outside the wells and the first trough; at the second position, the first capillary ends are inside the wells; and at the third position, the first capillary ends are inside the first trough.
21. The capillary array device of any of embodiments 18-20, wherein: the movable section is a first movable section comprising the wells and the first trough; the capillary array holder further comprises a second movable section linearly translatable along the device axis relative to the capillaries and the stationary section; and the second capillary ends are movable into and out from the second trough in response to movement of the second movable section.
22. The capillary array device of embodiment 21, wherein the second movable section comprises the second trough.
23. The capillary array device of any of embodiments 21-22, wherein: the capillary array holder further comprises a third trough extending along the transverse axis; and the first capillary ends are movable into and out from the third trough in response to movement of the first movable section.
24. The capillary array device of embodiment 23, wherein: the first movable section is configured to move among a first position, a second position, and a third position; at the first position, the first capillary ends are inside the first trough; at the second position, the first capillary ends are inside the third trough; and at the third position, the first capillary ends are inside the wells.
25. The capillary array device of embodiment 24, wherein the second movable section is configured to move to the third position, at which the second capillary ends are inside the second trough.
26. The capillary array device of any of the preceding embodiments, wherein the stationary section and/or the movable section comprises a guide feature configured to guide the movement of the movable section.
27. The capillary array device of embodiment 26, wherein the guide feature comprises a leg extending from at least one of the stationary section or the movable section, and the leg extends along the device axis adjacent to the other of the stationary section or the movable section.
28. The capillary array device of embodiment 27, wherein the guide feature comprises a recess axially aligned with the leg, and in response to movement of the movable section, either the leg moves into the recess or the recess moves around and adjacent to the leg.
29. The capillary array device of any of the preceding embodiments, wherein the flexible section comprises a compliant spring configured to bias the movable member in a direction along the device axis.
30. The capillary array device of any of the preceding embodiments, wherein at least a portion of the flexible section is composed of a material that is more flexible than materials of the stationary section and the movable section.
31. The capillary array device of any of the preceding embodiments, wherein at least a portion of the flexible section has an open-frame configuration.
32. The capillary array device of embodiment 31, wherein the open-frame configuration comprises a plurality of structural members defining a plurality of holes extending through the flexible section.
33. The capillary array device of any of the preceding embodiments, wherein at least a portion of the flexible section is interposed between the stationary section and the movable section along the device axis.
34. The capillary array device of any of the preceding embodiments, wherein at least a portion of the flexible section is interposed between the stationary section and the movable section along a transverse axis orthogonal to the device axis.
35. The capillary array device of any of the preceding embodiments, wherein the movable section comprises a feature configured to be coupled to or contacted by an actuator.
36. The capillary array device of any of the preceding embodiments, comprising an actuator configured to move the movable section.
37. The capillary array device of embodiment 36, wherein the actuator comprises an actuating device and a mechanical link coupled to the actuating device and coupled to or contactable with the movable section.
38. The capillary array device of embodiment 36, wherein the actuator comprises an intrinsic actuator and an actuating device configured to induce actuation of the intrinsic actuator.
39. The capillary array device of embodiment 38, wherein the intrinsic actuator is selected from the group consisting of: a dielectric elastomer actuator; a shape-memory polymer; a shape-memory alloy; and a magnet.
40. The capillary array device of any of embodiments 38-39, wherein the actuating device is selected from the group consisting of: a voltage source; a heat source; a light source; and a magnetic source.
41. The capillary array device of any of embodiments 38-40, wherein the movable section and/or the flexible section comprises the intrinsic actuator.
42. A sample analysis system, comprising: a capillary array device according to any of the preceding embodiments; and a light detector positioned in optical alignment with the capillaries to receive light emitted from the capillaries.
43. The sample analysis system of embodiment 42, comprising a light source positioned in optical alignment with the detection area to transmit light to the capillaries.
44. The sample analysis system of any of embodiments 42-43, comprising a voltage source configured to apply a potential difference across the capillaries.
45. The sample analysis system of embodiment 44, wherein the voltage source is configured to apply the potential difference according to operating parameters effective for performing capillary electrophoresis on samples disposed in the capillaries.
46. The sample analysis system of any of embodiments 42-45, comprising an actuator configured to actuate movement of the movable section.
47. The sample analysis system of embodiment 46, wherein the actuator comprises a feature selected from the group consisting of: a mechanical or electromechanical actuating device coupled to a movable mechanical link; a voltage source; a heat source; a light source; and a magnetic source.
48. The sample analysis system of any of embodiments 42-47, comprising a device support configured to support the capillary array device in a fixed position.
49. A method for injecting a liquid or gel into a plurality of capillaries, the method comprising: providing a capillary array device comprising the plurality of capillaries and a capillary array holder, wherein: the capillary array holder comprises a stationary section, a movable section, and a flexible section coupling the stationary section and the movable section; and the capillaries are attached to the capillary array holder, and are arranged in parallel and elongated along a device axis of the capillary array holder; moving the movable section along the device axis to a position at which the capillaries extend into one or more containers of the capillary array holder, wherein the liquid or gel is contained in the one or more containers, and the flexible section flexes in response to movement of the movable section; and injecting the liquid or gel from the one or more containers into the capillaries by capillary action.
50. The method of embodiment 49, wherein the injecting comprises applying a voltage across each of the capillaries along the device axis to electrokinetically assist the injecting.
51. The method of any of embodiments 49-50, comprising, after the injecting, applying a voltage across each of the capillaries along the device axis to electrokinetically induce the liquid or gel in each capillary to flow through the capillary.
52. The method of any of embodiments 49-51, wherein the containers respectively contain samples to be analyzed, and the injecting comprises respectively injecting the samples into the capillaries.
53. The method of embodiment 52, comprising, after the injecting, applying a voltage across each of the capillaries along the device axis, wherein the voltage is applied according to operating parameters effective for performing capillary electrophoresis on the samples.
54. The method of any of embodiments 49-53, wherein the one or more containers comprise a plurality of wells, and each capillary is aligned with a respective one of the wells along the device axis.
55. The method of any of embodiments 49-54, wherein the one or more containers comprise a trough and, after the moving, the capillaries each extend into the trough.
56. The method of any of embodiments 49-55, wherein: the capillaries comprise respective first capillary ends and second capillary ends; the one or more containers comprise a plurality of wells, and the first capillary ends are movable into and out from the respective wells in response to movement of the movable section, and the liquid or gel injected from the wells is a first liquid or first gel injected through the first capillary ends; the capillary array holder comprises a trough containing a second liquid or second gel; and the method further comprises one of: injecting the second liquid or second gel into the second capillary ends by capillary action; moving the movable section along the device axis to a position at which the first capillary ends extend into the trough, and injecting the second liquid or second gel into the first capillary ends by capillary action.
57. The method of any of embodiments 49-56, wherein: the capillaries comprise respective first capillary ends and second capillary ends; the one or more containers comprise a plurality of wells, and the first capillary ends are movable into and out from the respective wells in response to movement of the movable section, and the liquid or gel injected from the wells is a first liquid or first gel injected through the first capillary ends; the capillary array holder comprises a first trough containing a second liquid or second gel; the capillary array holder comprises a second trough containing a third liquid or third gel; and the method further comprises: injecting the second liquid or second gel into the first capillary ends by capillary action; and injecting the third liquid or third gel into the second capillary ends by capillary action.
58. The method of embodiment 57, wherein: the movable section is a first movable section, and the capillary array holder comprises a second movable section; and before the injecting of the third liquid or third gel into the second capillary ends, moving the second movable section along the device axis to a position at which the second capillary ends extend into the second trough.
59. The method of embodiment 58, wherein: the capillary array holder comprises a third trough containing a fourth liquid or fourth gel; and the method further comprises, after the injecting of the second liquid or second gel into the first capillary ends, injecting the fourth liquid or fourth gel into the first capillary ends by capillary action.
60. The method of any of embodiments 49-59, wherein the moving of the movable section is done manually.
61. The method of any of embodiments 49-59, wherein the moving of the movable section comprises actuating the movement of the movable section.
62. The method of embodiment 61, wherein the actuating comprises moving an actuator into contact with the movable section, or operating an actuator that is coupled to the movable section.
63. The method of embodiment 61, wherein the actuating comprises magnetically coupling an actuator with a magnet of the capillary array holder.
64. The method of embodiment 61, wherein the actuating comprises activating an intrinsic actuator of the capillary array holder.
65. The method of embodiment 64, wherein the activating is selected from the group consisting of: applying an electric field to the intrinsic actuator, wherein the intrinsic actuator comprises a dielectric elastomer actuator; applying heat energy to the intrinsic actuator, wherein the intrinsic actuator comprises a shape-memory polymer; applying a light beam to the intrinsic actuator, wherein the intrinsic actuator comprises a shape-memory polymer; applying an electric field to the intrinsic actuator, wherein the intrinsic actuator comprises a shape-memory polymer; applying a magnetic field to the intrinsic actuator, wherein the intrinsic actuator comprises a shape-memory polymer; and applying heat energy to the intrinsic actuator, wherein the intrinsic actuator comprises a shape-memory alloy.
66. A method for analyzing samples, comprising: injecting the liquid or gel into the capillaries according to the method of any of embodiments 49-65, wherein the liquid or gel comprises samples to be analyzed, and the injecting comprises respectively injecting the samples into the capillaries; and making an optical measurement of the samples in the capillaries to acquire optical data from one or more analytes of the samples.
67. The method of embodiment 66, wherein the making of the optical measurement comprises detecting emission light emitted from the capillaries.
68. The method of any of embodiments 66-67, wherein the making of the optical measurement comprises irradiating the samples with excitation light.
69. The method of any of embodiments 66-68, comprising, before and/or during the making of the optical measurement, analytically separating the samples in each capillary.
70. The method of embodiment 69, wherein the analytically separating of the samples comprises performing capillary electrophoresis on the samples.

It will be understood that terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

1. A capillary array device, comprising:
a capillary array holder comprising a stationary section, a movable section, and a flexible section coupling the stationary section and the movable section; and
a plurality of capillaries attached to the capillary array holder, wherein the capillaries are arranged in parallel and elongated along a device axis of the capillary array holder, and wherein:
the movable section is linearly movable along the device axis relative to the capillaries and the stationary section; and
the flexible section flexes in response to movement of the movable section.

2. The capillary array device of claim 1, wherein the capillary array holder comprises a plurality of wells configured to contain respective liquids or gels, and the wells are positioned such that each capillary is aligned with a respective one of the wells along the device axis, and wherein the capillaries are movable into and out from the respective wells in response to movement of the movable section.

3. The capillary array device of claim 2, wherein:
the capillaries comprise respective first capillary ends and second capillary ends opposing the first capillary ends along the device axis; and
the movable section is configured to move from a first position at which the first capillary ends are outside the wells, to a second position at which the first capillary ends are inside the wells.

4. The capillary array device of claim 2, wherein the capillary array holder comprises a plurality of electrodes, and each electrode is positioned in a respective one of the wells.

5. The capillary array device of claim 1, wherein:
the capillaries are arranged side-by-side along a transverse axis orthogonal to the device axis; and
the capillary array holder comprises a trough extending along the transverse axis and configured to contain a liquid or a gel, and the trough is wide enough along the transverse axis to receive all of the capillaries simultaneously.

6. The capillary array device of claim 5, wherein the capillary array holder comprises an electrode is positioned in the trough.

7. The capillary array device of claim 1, wherein:
the capillaries are arranged side-by-side along a transverse axis orthogonal to the device axis;
the capillaries comprise respective first capillary ends and second capillary ends opposing the first capillary ends along the device axis;
the capillary array holder comprises a plurality of wells configured to contain respective liquids or gels, and the wells are positioned such that each first capillary end is aligned with a respective one of the wells along the device axis, and wherein the first capillary ends are movable into and out from the respective wells in response to movement of the movable section;
the capillary array holder comprises a trough extending along the transverse axis, and the capillary array holder has a configuration according to one of: the second capillary ends are disposed in the trough in a fixed manner; and
the first capillary ends are movable into and out from the trough in response to movement of the movable section.

8. The capillary array device of claim 1, wherein:
the capillaries are arranged side-by-side along a transverse axis orthogonal to the device axis;
the capillaries comprise respective first capillary ends and second capillary ends opposing the first capillary ends along the device axis;
the capillary array holder comprises a plurality of wells configured to contain respective liquids or gels, and the wells are positioned such that each first capillary end is aligned with a respective one of the wells along the device axis, and wherein the first capillary ends are movable into and out from the respective wells in response to movement of the movable section;
the capillary array holder comprises a first trough, and the first trough is positioned along the transverse axis in alignment with the first capillary ends, and wherein the first capillary ends are movable into and out from the first trough in response to movement of the movable section; and
the capillary array holder comprises a second trough extending along the transverse axis and configured to receive the second capillary ends.

9. The capillary array device of claim 8, wherein:
the movable section is configured to move among a first position, a second position, and a third position;
at the first position, the first capillary ends are outside the wells and the first trough;
at the second position, the first capillary ends are inside the wells; and
at the third position, the first capillary ends are inside the first trough.

10. The capillary array device of claim 8, wherein:
the movable section is a first movable section comprising the wells and the first trough;
the capillary array holder further comprises a second movable section linearly translatable along the device axis relative to the capillaries and the stationary section; and
the second capillary ends are movable into and out from the second trough in response to movement of the second movable section.

11. The capillary array device of claim 10, wherein:
the capillary array holder further comprises a third trough extending along the transverse axis; and
the first capillary ends are movable into and out from the third trough in response to movement of the first movable section.

12. The capillary array device of claim 11, wherein:
the first movable section is configured to move among a first position, a second position, and a third position;
at the first position, the first capillary ends are inside the first trough;
at the second position, the first capillary ends are inside the third trough; and
at the third position, the first capillary ends are inside the wells.

13. The capillary array device of claim 12, wherein the second movable section is configured to move to the third position, at which the second capillary ends are inside the second trough.

14. The capillary array device of claim 1, wherein the flexible section comprises at least one of the following features:
the flexible section comprises a compliant spring configured to bias the movable section in a direction along the device axis;
at least a portion of the flexible section is composed of a material that is more flexible than materials of the stationary section and the movable section;
at least a portion of the flexible section has an open-frame configuration;
at least a portion of the flexible section has an open-frame configuration, and the open-frame configuration comprises a plurality of structural members defining a plurality of holes extending through the flexible section;
at least a portion of the flexible section is interposed between the stationary section and the movable section along the device axis; and
at least a portion of the flexible section is interposed between the stationary section and the movable section along a transverse axis orthogonal to the device axis.

15. The capillary array device of claim 1, comprising an actuator configured to move the movable section.

16. The capillary array device of claim 15, wherein the actuator comprises at least one of the following features:
an actuating device and a mechanical link coupled to the actuating device and coupled to or contactable with the movable section;
an intrinsic actuator and an actuating device configured to induce actuation of the intrinsic actuator;
an intrinsic actuator and an actuating device configured to induce actuation of the intrinsic actuator, wherein the intrinsic actuator is selected from the group consisting of: a dielectric elastomer actuator, a shape-memory polymer, a shape-memory alloy, and a magnet;
an intrinsic actuator and an actuating device configured to induce actuation of the intrinsic actuator, wherein the actuating device is selected from the group consisting of: a voltage source, a heat source, a light source, and a magnetic source; and
an intrinsic actuator and an actuating device configured to induce actuation of the intrinsic actuator, wherein the movable section and/or the flexible section comprises the intrinsic actuator.

17. The capillary array device of claim 1, comprising a plurality of electrodes configured to apply the potential difference according to operating parameters effective for performing capillary electrophoresis on samples disposed in the capillaries.

18. A sample analysis system, comprising:
the capillary array device of claim 1; and
a light detector positioned in optical alignment with the capillaries to receive light emitted from the capillaries.

19. A method for injecting a liquid or gel into a plurality of capillaries, the method comprising:
providing a capillary array device comprising the plurality of capillaries and a capillary array holder, wherein:
the capillary array holder comprises a stationary section, a movable section, and a flexible section coupling the stationary section and the movable section; and
the capillaries are attached to the capillary array holder, and are arranged in parallel and elongated along a device axis of the capillary array holder;
moving the movable section along the device axis to a position at which the capillaries extend into one or more containers of the capillary array holder, wherein the liquid or gel is contained in the one or more containers, and the flexible section flexes in response to movement of the movable section; and
injecting the liquid or gel from the one or more containers into the capillaries by capillary action.

20. A method for analyzing samples, comprising:
injecting the liquid or gel into the capillaries according to the method of claim 19, wherein the liquid or gel comprises samples to be analyzed, and the injecting comprises respectively injecting the samples into the capillaries; and
making an optical measurement of the samples in the capillaries to acquire optical data from one or more analytes of the samples.
